(19) United States
(12) Patent Application Publication
(10) Pub. No.: US 2024/0218255 A1
(43) Pub. Date: Jul. 4, 2024

(54) CONVERTING BIOMASS TO GASOLINE

(71) Applicant: ABUNDIA BIOMASS-TO-LIQUIDS LIMITED, Teesside (GB)

(72) Inventor: Martin Atkins, Redcar (GB)

(21) Appl. No.: 18/270,587

(22) PCT Filed: Dec. 31, 2021
(86) PCT No.: PCT/EP2021/087898

§ 371 Date: Jun. 30, 2023

(30) Foreign Application Priority Data
Dec. 31, 2020 (GB) 2020914.4

(51) Int. Cl. C10G 1/06; C10G 69/04

(52) U.S. Cl. CPC C10G 1/06; C10G 69/04; C10G 2300/1014; C10G 2300/201; C10G 2300/4006; C10G 2300/4012; C10G 2300/70; C10G 2400/02; C10G 2400/04; C10G 2400/08

(57) ABSTRACT

The present invention relates to a process and system for forming a bio-derived gasoline fuel from a biomass feedstock, and the bio-derived gasoline fuel formed therefrom. The present invention also relates to a process and system for forming a bio-derived gasoline fuel from a bio-derived hydrocarbon feedstock, and the bio-derived gasoline fuel formed therefrom.

### FIELD OF INVENTION

The present invention relates to a process and system for forming a bio-derived gasoline fuel from a biomass feedstock, and the bio-derived gasoline fuel formed therefrom. The present invention also relates to a process and system for forming a bio-derived gasoline fuel from a bio-derived hydrocarbon feedstock, and the bio-derived gasoline fuel formed therefrom.

### BACKGROUND

Demand for energy has increased over the years due to greater dependence on technology both in a personal and commercial capacity, expanding global population and the required technological progress made in developing countries. Energy resources have traditionally been derived primarily from fossil fuels however, as supply of such resources declines, a greater significance is placed on research looking at alternative methods of providing energy. Further, increased awareness of the environmental impact of burning fossil fuels and commitments to reducing the emission of greenhouse gases has significantly increased the demand for greener energy resources.

Bio-fuels are considered to be a promising, more environmentally-friendly alternative to fossil fuels, in particular, diesel, naphtha, gasoline and jet fuel. Presently, such materials are only partly replaced with bio-derived fuels through blending. Due to the costs associated with the formation of some bio-fuels it is not yet commercially viable to manufacture fuels entirely derived from biomass materials. Even where bio-derived fuels are combined with fossil fuels, difficulties in blending some bio-derived fuels can lead to extended processing times and higher costs.

The term biomass is commonly used with respect to materials formed from plant-based sources, such as corn, soy beans, flaxseed, rapeseed, sugar cane, and palm oil, however this term encompasses materials formed from any recently living organisms, or their metabolic by-products. Biomass materials comprise lower amounts of nitrogen and sulphur compared to fossil fuels and produce no net increase in atmospheric CO₂ levels, and so the formation of an economically viable bio-derived fuel would be environmentally beneficial.

High quality fossil fuels, such as diesel and gasoline are formed by refining crude oils. The gasoline fuels produced mainly comprise paraffins (alkanes), olefins (alkenes) and cycloalkanes (naphthenes). The refining process typically include additional refining/upgrading processes, including hydro-treating processes to reduce the amount of sulphur present, catalytic cracking and/or hydrocracking to reduce the presence of larger hydrocarbon compounds, and optionally blending with other streams, in order to produce a fuel meeting all of the requisite chemical, physical, economic and inventory requirements of a gasoline product.

Fossil fuel-based gasoline is formed from a complex mixture of hydrocarbon compounds, wherein the majority of hydrocarbon compounds comprise a carbon number of between 4 and 12. For a bio-fuel to be considered fungible to crude oil-based gasoline fuels, it must also meet the standardised chemical and physical properties of these materials, as defined in Directive 2009/30/EC.

In Europe, the standard requirements for gasoline-based fuels are becoming ever more stringent in order to meet lower target emission requirements and improve fuel efficiency. The most recent requirements for gasoline fuels are defined by EURO VI, (Euro 6dTEMP (from 2017), Euro 6d (from 2020)). The requirements of category VI unleaded gasoline fuels are defined in “Worldwide Fuel Charter: Sixth Edition—Gasoline and Diesel Fuel”, some of the standard requirements of a Euro 6 grade unleaded gasoline fuel are shown in Table 1 below.

TABLE 1

| | | Limits | | |
|---|---|---|---|---|
| Property | Unit | Minimum | Maximum | Test Method |
| 98 RON | | | | |
| Research Octane Number | | 98.0 | | ISO: EN 5164, ASTM: D2699 |
| Motor Octane Number | | 88.0 | | ISO: EN 5163, ASTM: D2700 |
| 102 RON | | | | |
| Research Octane Number | | 102.0 | | ISO: EN 5164, ASTM: D2699 |
| Motor Octane Number | | 88.0 | | ISO: EN 5163, ASTM: D2700 |
| Sulphur | Mg/kg | | 10 | ISO: 20846, ASTM: D2622 |
| Oxygen | % m/m | | 3.7 | ISO: EN 22854, ASTM: |
| | | | | D4815, D5599 |
| Olefins | % v/v | | 10.0 | ISO: 3837, ASTM: D1319 |
| Aromatics | % v/v | | 35.0 | ISO: 3837, ASTM: D1319 |
| Benzene | % v/v | | 1.0 | ISO: EN 22854, ASTM: |
| | | | | D5580, D3606 |
| Density | Kg/m³ | 720 | 775 | ISO: 3675, 12185, ASTM: |
| | | | | D4052 |

Particularly important requirements for any gasoline fuel (or hydrocarbon feedstock for use in forming a gasoline fuel) are i) the amount of sulphur present, and ii) the amount of diene containing compounds present. Combustion of sulphur containing hydrocarbons leads to the formation of sulphur oxides. Sulphur oxides are considered to contribute to the formation of aerosol and particulate matter (soot) which can lead to reduced flow or blockages in filters and component parts of combustion engines. Furthermore, sulphur oxides are known to cause corrosion of turbine blades, and so high sulphur content in a fuel is highly undesirable.

The bromine number, or bromine index, is a parameter used to estimate the amount of unsaturated hydrocarbon groups present in the material. Unsaturated hydrocarbon bonds present within a bio-derived gasoline fuel can be detrimental to the physical properties and performance of the material. Unsaturated carbon bonds can crosslink or react with oxygen to form epoxides. Crosslinking causes the hydrocarbon compounds to polymerise forming gums or varnishes, wherein these gums and varnishes can form deposits within a fuel system or engine, blocking filters and/or tubing supplying fuel to the internal combustion engine. The reduced fuel flow results in a decrease of engine power and can even prevent the engine from starting. EURO V and EURO VI require that the olefin content of gasoline fuels is 18% or lower.

As gasoline fuels are highly flammable at ambient temperatures, the octane number can indicate the viability of such fuels in a combustion engine. The octane number is a measure of the resistance of a hydrocarbon to ignition when compressed in a standard, spark ignition internal combustion engine. As the octane number increases the likelihood of a hydrocarbon ‘knocking’ i.e. causing an explosion due to premature ignition in a combustion engine, is reduced. The octane number of a gasoline fuel is determined by calculating the average of the research octane number (RON) and the motor octane number (MON). The RON is determined by analysing the performance of the gasoline fuel under research test conditions (using a 600 rpm test engine with a variable compression ratio) and comparing the results with those for mixtures of iso-octane and n-heptane (as defined in ASTM D2699). The MON is determined by analysing the performance of the gasoline fuel under more severe operating conditions (using a 900 rpm engine, as defined in ASTM D 2700). Additives such as butane and aromatics can be used to increase the octane number of a gasoline fuel however such additives produce undesirable environmental effects. For example, butane is known to increase loss of unburned hydrocarbons through evaporation and aromatics may reduce engine cleanliness and increase engine deposits. The use of aromatic additives may also increase the amount of carcinogenic compounds present in exhaust gases, such as benzene and polyaromatic compounds.

It is well understood within this field that the physical properties of a gasoline fuel, such as the octane number, corrosive nature and vapour pressure, and therefore the performance of the fuel in a turbine engine, is linked to both the molecular weight or carbon number and the ratio of different hydrocarbon compounds present.

For a bio-derived fuel to be considered a fit for purpose gasoline fuel, it must meet the above standardised requirements. However, known methods of producing bio-derived oils typically produce wide range of hydrocarbon compounds, and thus require further significant and costly refining steps in order to bring the oil to an acceptable specification. Such methods cannot provide an economically competitive alternative to fossil fuels.

Research within this field has previously been focused on indirect methods of forming bio-fuels, comprising, for example i) the fractionation of biomass and fermentation of the cellulosic and hemicellulosic fraction to ethanol, or ii) the destructive gasification of the complete biomass to form syngas before subsequent upgrading to methanol or Fischer-Tropsch methods.

Thermo-conversion methods are currently considered to be the most promising technology in the conversion of biomass to bio-fuels. Thermo-chemical conversion includes the use of pyrolysis, gasification, liquefaction and supercritical fluid extraction. In particular, research has focussed on pyrolysis and gasification for forming bio-fuels.

Gasification comprises the steps of heating biomass materials to temperatures of over 430° C. in the presence of oxygen or air in order to form carbon dioxide and hydrogen (also referred to as synthesis gas or syngas). Syngas can then be converted into liquid fuel using a catalysed Fischer-Tropsch synthesis. The Fischer-Tropsch reaction is usually catalytic and pressurised, operating at between 150 and 300° C. The catalyst used requires clean syngas and so additional steps of syngas cleaning are also required.

A typical gasification method comprising a biomass material produces a H₂:CO ratio of around 1, as shown in Equation 1 below:

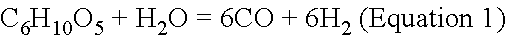

Accordingly, the reaction products are not formed in the ratio of CO to H₂ required for the subsequent Fischer-Tropsch synthesis to form bio-fuels (H₂:CO ratio of ˜ 2). In order to increase the ratio of H₂ to CO, the following additional steps are commonly applied:
An additional water gas shift reaction is used;
Hydrogen gas is added;
Carbon is extracted using gasification;
increased amounts of CO₂ are produced by using excess steam: C₆H₁₀O₅+7 H₂O=6CO₂+12H₂. Carbon dioxide can be converted to carbon monoxide through the addition of carbon, referred to as gasification with carbon dioxide, instead of steam.
Unreacted CO is removed and used for forming of heat and/or power.

Overall, the gasification reaction requires multiple reaction steps and additional reactants, and so the energy efficiency of producing a biofuel in this manner is low. Furthermore, the increased time, energy requirements, reactants and catalysts required to combine gasification and Fischer-Tropsch reactions greatly increases manufacturing costs.

Of the thermo-conversion processes, pyrolysis methods are considered to be the most efficient pathway to convert biomass into a bio-derived oil. Pyrolysis methods produce bio-oil, char and non-condensable gases by rapidly heating biomass materials in the absence of oxygen. The ratio of products produced is dependent on the reaction temperature, reaction pressure and the residence time of the pyrolysis vapours formed.

Higher amounts of biochar are formed at lower reaction temperatures and lower heating rates; higher amounts of liquid fuel are formed using lower reaction temperatures, higher heating rates and shorter residence times; and fuel gases are preferentially formed at higher reaction temperatures, lower heating rates and longer residence times. Pyrolysis reactions are split into three main categories, conventional, fast and flash pyrolysis, depending on the reaction conditions used.

In a conventional pyrolysis process the heating rate is kept low (around 5 to 7ºC/min) heating the biomass up to temperatures of around 275 to 675° C. with residence times of between 7 and 10 minutes. The slower increase in heating typically results in higher amounts of char being formed compared to bio-oil and gases.

Fast pyrolysis comprises the use of high reaction temperatures (between 575 and 975° C.) and high heating rates (around 300 to 550° C./min) and shorter residence times of the pyrolysis vapour (typically up to 10 seconds) followed by rapid cooling. Fast pyrolysis methods increase the relative amounts of bio-oil formed.

Flash pyrolysis comprises rapid devolitalisation in an inert atmosphere, a high heating rate, high reaction temperatures (typically greater than 775° C.) and very short vapour residence times (<1 second). In order for heat to be sufficiently transferred to the biomass materials in these limited time periods, the biomass materials are required to be present in particulate form with diameters of about 1 mm being common. The reaction products formed are predominantly gas fuel.

However, bio-oils produced through a pyrolysis process often comprise a complex mixture of water and various organic compounds, including acids, alcohols, ketones, aldehydes, phenols, esters, sugars, furans, and hydrocarbons, as well as larger oligomers. The presence of water, acids, aldehydes and oligomers are considered to be responsible for poor fuel properties in the bio-oil formed.

Furthermore, the resulting bio-oil can contain 300 to 400 different oxygenated compounds, which can be corrosive, thermally and chemically unstable and immiscible with petroleum fuels. The presence of these oxygenated compounds also increases the viscosity of the fuels and increases moisture absorption.

In order to address these issues, several upgrading techniques have been proposed, including catalytic (hydro)deoxygenation using hydro-treating catalysts, supported metallic materials, and most recently transition metals. However, catalyst deactivation (via coking) and/or inadequate product yields means that further research is required.

Alternative upgrading techniques include emulsification catalytic hydrogenation, fluidised catalysed cracking and/or catalytic esterification. However, as previously known methods of producing a bio-derived hydrocarbon feedstock result in a wide range of hydrocarbon compounds, including significant amounts of contaminants and/or undesirable components, the bio-derived hydrocarbon feedstock may not be sufficiently stable to undergo upgrading cracking processes, such as fluid catalysed cracking, and can repolymerise blocking or reducing the flow within such reactor systems. Inevitably, the need for additional refinement steps and additional reactant materials increases both the time and cost associated with such processes both in terms of operating costs and capital expenditure.

Due to the poor quality of bio-derived hydrocarbon feedstocks or bio-derived fuels produced using previously known methods, it is often necessary to blend the hydrocarbon feedstock with a fossil fuel or a fraction thereof prior to fluidised catalytic cracking techniques or alternatively blending the bio-derived fuel formed with a fossil fuel or fraction thereof in order to the meet the chemical, physical and economic requirements discussed above. In some cases, the weight ratio of the fossil fuel or fraction thereof to the bio-derived hydrocarbon feed/bio-derived fuel can be up to 99.9:0.1 in order to produce a fuel meeting the current standard requirements.

Accordingly, there remains a need in the art for a more concise and efficient method of forming a bio-derived gasoline fuel, which can meet at least some of the standardised chemical, physical and performance properties of the fossil fuel-based materials. In particular, it would be desirable to provide a more cost-effective method of producing bio-derived fuels comparable to those produced from fossil fuels.

### DESCRIPTION OF THE INVENTION

In a first embodiment, the present invention relates to a process for forming a bio-gasoline fuel from a biomass feedstock, comprising the steps of:
a. providing a biomass feedstock;
b. ensuring the moisture content of the biomass feedstock is 10% or less by weight of the biomass feedstock;
c. pyrolysing the low moisture biomass feedstock at a temperature of at least 950° C. to form a mixture of biochar, hydrocarbon feedstock, non-condensable light gases, such as hydrogen, carbon monoxide, carbon dioxide and methane, and water;
d. separating the hydrocarbon feedstock from the mixture formed in step c;
e. cracking the hydrocarbon feedstock of step d. using a fluidised catalytic cracking (FCC) process to produce a bio-oil; and
f. fractionating the resulting bio-oil to obtain a bio-derived gasoline fuel fraction.

Preferably, the biomass feedstock comprises cellulose, hemicellulose or a lignin-based feedstock.

Whilst it is possible to use food crops, such as corn, sugar cane and vegetable oil as a source of biomass, it has been suggested that the use of such starting materials can lead to other environmental and/or humanitarian issues. For example, where food crops are used as a biomass source, more land must be dedicated to growing the additional crops required or a portion of the crops currently grown must be diverted for this use, leading to further deforestation or an increase in the cost of certain foods. Accordingly, in a preferred embodiment of the present invention the biomass feedstock is selected from a non-crop biomass feedstock.

In particular, it has been found that suitable biomass feedstocks may be preferably selected from miscanthus, switchgrass, garden trimmings, straw, such as rice straw or wheat straw, cotton gin trash, municipal solid waste, palm fronds/empty fruit bunches (EFB), palm kernel shells, bagasse, wood, such as hickory, pine bark, Virginia pine, red oak, white oak, spruce, poplar, and cedar, grass hay, mesquite, wood flour, nylon, lint, bamboo, paper, corn stover, or a combination thereof.

During combustion of a hydrocarbon feedstock or a bio-fuel, sulphur contained therein may be oxidised and can further react with water to produce sulphuric acid (H₂SO₄). The sulphuric acid formed can condense on the metal surfaces of combustion engines causing corrosion. Thus, further or repeated processing steps are required to reduce the sulphur content of bio-oils to a suitable level. This in turn increases the processing time to produce a viable bio-fuel and increases the cost associated with manufacturing these materials. Accordingly, the biomass feedstock can be selected from a low sulphur biomass feedstock. In general, non-crop biomass feedstocks contain low amounts of sulphur, however particularly preferred low sulphur biomass feedstocks include miscanthus, grass, and straw, such as rice straw or wheat straw.

The use of a low sulphur biomass feedstock reduces the extent to which the resulting hydrocarbon feedstock will be required to undergo desulphurisation processing in order to meet industry requirements, in some cases the need for a desulphurisation processing step is eliminated.

During the pyrolysis step, the efficiency of heat transfer through the biomass material has been found to be at least partially dependent on the surface area and volume of the biomass material used. Thus, preferably, the biomass feedstock is ground in order break up the biomass material and/or to reduce its particle size, for example through the use of a tube grinder, a mill, such as a hammer mill, knife mill, slurry milling, or resized through the use of a chipper, to the required particle size. Preferably, the biomass feedstock is provided in the form of pellets, chips, particulates or a powder. More preferably, the pellets, chips, particulates or powders have a diameter of from 5 μm to 10 cm, such as from 5 μm to 25 mm, preferably from 50 μm to 18 mm, more preferably from 100 μm to 10 mm. These sizes have been found to be particularly useful with respect to efficient heat transfer. The diameter of the pellets, chips, particulates and powders defined herein relate to the largest measurable width of the material.

It has also been found that, at high temperatures, such as those required during the high-temperature pyrolysis reaction, the presence of smaller particles can result in an increased chance of dust explosions and fires. However, it has been found that by at least partially removing or preventing the formation of biomass pellets, chips, particles or powders with a diameter of less than about 1 mm, the likelihood of dust explosions or fire occurring is significantly reduced. Accordingly, it is preferable for the biomass feedstock (generally in the form of pellets, chips, particulates or powder) to have a diameter of at least 1 mm, such as from 1 mm to 25 mm, 1 mm to 18 mm or 1 mm to 10 mm. The biomass feedstock may comprise surface moisture. Preferably, such moisture is reduced prior to the step of pyrolysing the biomass feedstock. The amount of moisture present in the biomass feedstock will vary depending on the type of biomass material, transport and storage conditions of the material before use. For example, fresh wood can contain around 50 to 60% moisture. The presence of increased amounts of moisture in the biomass feedstock has been found to reduce the efficiency of the pyrolysis step of the present invention as heat is lost through evaporation of the moisture—rather than heating the biomass material itself, thereby reducing the temperature to which the biomass material is heated or increasing the time to heat the biomass material to the required temperature. This in turn affects the desired ratio of pyrolysis products formed in the hydrocarbon feedstock product.

By way of example, the initial moisture content of the biomass feedstock may be from 10% to 50% by weight of the biomass feedstock, such as from 15% to 45% by weight of the biomass feed stock, or for example from 20% to 30% by weight of the biomass feedstock.

Preferably, the moisture content of the biomass feedstock is reduced to 7% or less by weight, such as 5% or less by weight of the biomass feedstock.

Optionally, the moisture of the biomass feedstock is at least partially reduced before the biomass feedstock is ground.

Alternatively, the biomass feedstock may be formed into pellets, chips, particulates or a powder before the moisture content of the biomass feedstock is at least partially reduced to 10% or less by weight of the biomass feedstock, for example where the forming process is a “wet” process or wherein the removal of at least some moisture from the biomass feedstock may be achieved more efficiently by increasing the surface area of the biomass feedstock material.

The amount of moisture present may be reduced through the use of a vacuum oven, a rotary dryer, a flash dryer or a heat exchanger, such as a continuous belt dryer. Preferably, moisture is reduced through the use of indirect heating methods, such as indirect heat belt dryer, an indirect heat fluidised bed or an indirect heat contact rotary steam-tube dryer.

Indirect heating methods have been found to improve the safety of the overall process as the heat can be transferred in the absence of air or oxygen thereby alleviating and/or reducing the occurrence of fires and/or dust explosions. Furthermore, such indirect heating methods have been found to provide more accurate temperature control which, in turn, allows for better control of the ratio of pyrolysis products formed in the hydrocarbon feedstock product. In preferred processes, the indirect heating method comprises an indirect heat contact rotary steam-tube dryer wherein water vapour is used as a heat carrier medium.

The low moisture biomass feedstock may be pyrolysed at a temperature of at least 1000° C., more preferably at least 1100° C., for example 1120° C., 1150° ° C., or 1200° C.

In general, the biomass feedstock may be heated by convection heating, microwave heating, electrical heating or supercritical heating. By way of example, the biomass feedstock may be heated through the use of microwave assisted heating, a heating jacket, a solid heat carrier, a tube furnace or an electric heater. Preferably, the heating source is a tube furnace. The tube furnace may be formed from any suitable material, for example a nickel metal alloy.

As noted above, the use of indirect heating of the pyrolysis chamber is preferred as it reduces and/or alleviates the likelihood of dust explosions or fires occurring.

Alternatively or in addition, a heating source is positioned within the pyrolysis reactor in order to directly heat the low moisture biomass feedstock. The heating source may be selected from an electric heating source, such as an electrical spiral heater. It has been found to be beneficial to use two or more electrical spiral heaters within the pyrolysis reactor. The use of multiple heaters can provide a more homogenous distribution of heat throughout the reactor ensuring a more uniform reaction temperature is applied to the low moisture biomass material.

It has been found to be beneficial for the biomass material from step b. to be transported continuously through the pyrolysis reactor. For example, the biomass material may be transported through the pyrolysis reactor using a conveyor, such as a screw conveyor or a rotary belt. Optionally, two or more conveyors can be used to continuously transport the biomass material through the pyrolysis reactor. A screw conveyor has been found to be particularly useful as the speed at which the biomass material is transported through the pyrolysis reactor, and therefore the residence time in the pyrolysis reactor, can be controlled by varying the pitch of the screw conveyor.

Alternatively or in addition, the residence time of the biomass material within the reactor can be varied by altering the width or diameter of the pyrolysis reactor through which the biomass material is conveyed.

The biomass material may be pyrolysed under atmospheric pressure (including essentially atmospheric conditions). Preferably, the biomass material is pyrolysed in an oxygen-depleted environment in order to avoid the formation on unwanted oxygenated compounds, more preferably the biomass material is pyrolysed in an inert atmosphere, for example the reactor is purged with an inert gas, such as nitrogen or argon prior to the pyrolysis step. The biomass material may be pyrolysed under atmospheric pressure (including essentially atmospheric conditions). Alternatively, the biomass material may be pyrolysed under a low pressure, such as from 850 to 1,000 Pa, preferably 900 to 950 Pa. The resulting pyrolysis gases can subsequently be separated by any known methods within this field, for example through condensation and distillation The application of pressure, such as between 850 to 1,000 Pa, during the pyrolysis step and subsequent condensation and distillation of the pyrolysis gases formed has been found to be beneficial in separating the pyrolysis gases from any remaining solids formed during the pyrolysis reaction, such as biochar. Thus, in some embodiments, means are provided for applying the necessary vacuum pressure and/or removing pyrolysis gases formed.

In particular examples, the biomass material is conveyed in a counter-current direction to any pyrolysis gases formed, and any solid material, such as biochar formed as a result of the pyrolysis step is removed separate to the pyrolysis gases formed. As the hot pyrolysis gases pass through the biomass material, heat is transferred from the pyrolysis gases to the biomass material resulting in at least a minor amount of low-temperature pyrolysis of the biomass material.

In addition, the pyrolysis gases are at least partially cleaned as dust and heavy carbons present in the gases are captured by the biomass material.

Where the pyrolysis step is performed under low pressure conditions, a vacuum may be applied so as to aid the flow of pyrolysis gases in a counter-current direction to the biomass material being conveyed through the pyrolysis reactor, and optionally the removal of the pyrolysis gases.

In some examples, the biomass feedstock from step b. is pyrolysed for a period of from 10 seconds to 2 hours, preferably, from 30 seconds to 1 hour, more preferably from 60 second to 30 minutes, such as 100 seconds to 10 minutes.

In accordance with the present invention, step d. may further comprise the step of separating the biochar from the hydrocarbon feedstock product. In some examples, the separation of biochar from the hydrocarbon feedstock product occurs in the pyrolysis reactor. In other examples, the pyrolysis gases formed are first cooled, for example through the use of a venturi, in order to condense the hydrocarbon feedstock product and the biochar is subsequently separated from the liquid hydrocarbon feedstock product and non-condensable gases formed.

The amount of biochar formed in the pyrolysis step may be from 5% to 20% by weight of the biomass feedstock formed in step b., preferably the amount of biochar formed is from 10 to 15% by weight of the biomass feedstock formed in step b.

The hydrocarbon feedstock product may be at least partially separated from the biochar formed using filtration methods (such as the use of a ceramic filter), centrifugation, cyclone or gravity separation.

In accordance with the present invention, step d. may comprise or additionally comprises at least partially separating water from the hydrocarbon feedstock product. It has been found that the water at least partially separated from the hydrocarbon feedstock further comprises organic contaminants, such as pyroligneous acid. Generally, pyroligneous acid is present in the water at least partially separated from the hydrocarbon feedstock product in amounts of from 10% to 30% by weight of the aqueous pyroligneous acid, preferably, pyroligneous acid is present in an amount of from 15% to 28% by weight of the aqueous pyroligneous acid.

Aqueous pyrolignous acid (also referred to as wood vinegar) mainly comprises water but also contains organic compounds such as acetic acid, acetone and methanol. Wood vinegar is known to be used for agricultural purposes such as, as an anti-microbiological agent and a pesticide. In addition, wood vinegar can be used as a fertiliser to improve soil quality and can accelerate the growth of roots, stems, tubers flowers and fruits in plant. Wood vinegar is also known to have medicinal applications, for example in wood vinegar has antibacterial properties, can provide a positive effect on cholesterol, promotes digestion and can help alleviate acid reflux, heartburn and nausea. Thus, there is a further benefit to the present process in being able to isolate such a product stream.

The water may be at least partially separated from the hydrocarbon feedstock by gravity oil separation, centrifugation, cyclone or microbubble separation.

In accordance with the present invention, step d. may comprise or additionally comprises at least partially separating non-condensable light gases from the hydrocarbon feedstock product. The non-condensable light gases may be separated from the hydrocarbon feedstock product through any known methods within this field, for example by means of flash distillation or fractional distillation.

Generally, the non-condensable light gases may be at least partially recycled. Preferably, the non-condensable light gases separated from the hydrocarbon feedstock product are combined with the biomass feedstock being subjected to pyrolysis (step c.).

Where the non-condensable light gases comprise carbon monoxide, carbon monoxide contained therein can be at least partially separated and further processed in a water gas shift (WGS) reaction. In particular, carbon monoxide produced in the pyrolysis step can be combined with steam to produce carbon dioxide and a hydrogen gas fuel. Given that the feedstock used in the WSG reaction is derived from a biomass feedstock, the hydrogen gas produced is a green bio-derived hydrogen gas. Preferably carbon monoxide is contacted with steam at a temperature of from 205° C. to 482° C. As the WGS reaction is exothermic, carbon monoxide is more preferably contacted with steam at a temperature of from 205° C. to 260° C. in order to increase the yield of bio-derived hydrogen gas.

A shift catalyst may also be present in the WGS reaction, wherein the catalyst may be selected from a copper-zinc-aluminium catalyst or a chromium or copper promoted iron-based catalyst. Preferably the catalyst is selected from a copper-zinc-aluminium catalyst. In order to increase contact between carbon monoxide, steam and the selected shift catalyst, and thus improve the efficiency of the WGS reaction, the catalyst may be contained in a fixed bed or trickle bed reactor.

Bio-derived hydrogen gas produced through the WGS reaction may be at least partly recycled and used in further processing or “upgrading” steps downstream. For example, the bio-derived hydrogen gas produced can at least partially be used in downstream processing steps such as desulphurisation, deoxygenation and/or hydro-treating steps.

It can be beneficial to further process the hydrocarbon feedstock product to at least partially remove contaminants contained therein, such as carbon, graphene, polyaromatic compounds and tar. The presence of impurities in the bio-gasoline not only significantly affects its engine performance but also complicates its handling and storage. A filter, such as a membrane filter may be used to remove larger contaminants.

In addition or alternatively, fine filtration may be used to remove smaller contaminants which may be suspended in the hydrocarbon feedstock. By way of example, Nutsche filters may be used to remove smaller contaminants.

The step of filtering the hydrocarbon feedstock may be repeated two or more times in order to reduce the contaminants present to a desired level (for example, until the hydrocarbon feedstock is straw coloured).

Alternatively or in addition, contaminants, such as polycyclic aromatic compounds, may be removed by contacting the hydrocarbon feedstock with an active carbon compound and/or a crosslinked organic hydrocarbon resin. The hydrocarbon feedstock may be subsequently separated from the active carbon and/or crosslinked organic resin through any suitable means, such as filtration. In particular, the activated carbon and/or crosslinked organic hydrocarbon resin may be in particulate or pellet form in order to increase contact between the adsorbent and hydrocarbon feedstock, thereby reducing the time required to achieve the desired level of contaminant removal.

However, activated carbon can be costly to regenerate. As an alternative, biochar, for example such as formed in the present process, can be used as a more cost effective and environmentally friendly alternative to activated carbon in order to remove contaminants from the hydrocarbon feed.

As discussed above, crosslinked organic hydrocarbon resins may also be used to remove contaminants from the hydrocarbon feedstock product. In particular, crosslinked organic hydrocarbon resins are useful in removing organic-based contaminants through hydrophobic interaction (i.e. van der Waals) or hydrophilic interaction (hydrogen bonding, for examples with functional groups, such as carbonyl functional groups, present on the surface of the resin material). The hydrophobicity/hydrophilicity of the resin adsorbent material is dependent on the chemical composition and the structure of the resin material selected. Accordingly, the specific adsorbent resin can be tailored to the desired contaminants to be removed. Commonly used crosslinked organic hydrocarbon resins for the removal of contaminants present in biofuels include polysulfone, polyamides, polycarbonates, regenerated cellulose, aromatic polystyrenic or polydivinylbenzene, and aliphatic methacrylate. In particular, aromatic polystyrenic or polydivinylbenzene based resin materials can be used to remove aromatic molecules, such as phenols from the hydrocarbon feed.

In addition, adsorption of contaminant materials can be increased by increasing the surface area and porosity of the crosslinked organic polymer resin, and so in preferred embodiments the hydrocarbon feedstock is contacted with crosslinked organic hydrocarbon porous pellets or particles in order to further improve the purity of the treated hydrocarbon feedstock product and improve the efficiency of the purifying step.

Preferably, tar separated from the hydrocarbon feedstock product is at least partially recycled and combined with the biomass feedstock in step b. It has been found that the tar resulting from the pyrolysis of the biomass materials primarily comprises phenol-based compositions and a range of further oxygenated organic compounds. This pyrolysis tar can be further broken down by use of heat to at least partially form a hydrocarbon feedstock. Accordingly, by at least partially recycling the pyrolysis tar to the biomass feedstock in step b., the percentage yield of hydrocarbon feedstock product obtained from the biomass source can be increased.

The hydrocarbon feedstock product may be contacted with the activated carbon, biochar or crosslinked organic hydrocarbon resin at around atmospheric pressure (including essentially atmospheric conditions).

The activated carbon, biochar and/or crosslinked organic hydrocarbon resin may be contacted for any time necessary to sufficiently remove contaminants present within the hydrocarbon feedstock product. It is considered well within the knowledge of the skilled person within this field to determine a suitable contact times for the hydrocarbon feedstock and adsorbent materials. In some examples, the activated carbon, biochar and/or crosslinked organic hydrocarbon resin is contacted with the hydrocarbon feedstock for at least 15 minutes before separation, preferably at least 20 minutes, more preferably at least 25 minutes.

The step of contacting the hydrocarbon feedstock product with activated carbon, biochar and/or crosslinked organic hydrocarbon resin may be repeated one or more times, in order to reduce the contaminants present to a suitable level (for example, until the hydrocarbon feedstock is straw coloured).

The separated hydrocarbon feedstock formed in step d. preferably comprises at least 0.1% by weight of one or more C₈ compounds, at least 1% by weight of one or more C₁₀ compounds, at least 5% by weight of one or more C₁₂ compounds, at least 5% by weight of one or more C₁₆ compounds and at least 30% by weight of at least one or more C₁₈ compounds.

More preferably, the separated hydrocarbon feedstock formed in step d. comprises at least 0.5% by weight of one or more C₈ compounds, at least 2% by weight of one or more C₁₀ compounds, at least 6% by weight of one or more C₁₂ compounds; at least 6% by weight of one or more C₁₆ compounds and/or at least 33% by weight of one or more C₁₈ compounds.

The separated hydrocarbon feedstock preferably has a pour point of −10° C. or less, preferably −15° C. or less, such as −16° C. or less.

The separated hydrocarbon feedstock preferably comprises 300 ppmw or less, preferably 150 ppmw or less, more preferably 70 ppmw or less of sulphur.

A second embodiment provides a process for forming a bio-gasoline fuel from a bio-derived hydrocarbon feedstock, comprising the steps of:
i. providing a bio-derived hydrocarbon feedstock comprising at least 0.1% by weight of one or more C₈ compounds, at least 1% by weight of one or more C₁₀ compounds, at least 5% by weight of one or more C₁₂ compounds, at least 5% by weight of one or more C₁₆ compounds and at least 30% by weight of at least one or more C₁₈ compounds;
ii. cracking the hydrocarbon feedstock of step i. using a fluidised catalytic cracking (FCC) process to produce a bio-oil; and
iii. fractionating the resulting bio-oil to obtain a bio-derived gasoline fuel fraction.

Preferably, the bio-derived hydrocarbon feedstock comprises at least 0.5% by weight of one or more C₈ compounds, at least 2% by weight of one or more C₁₀ compounds, at least 6% by weight of one or more C₁₂ compounds; at least 6% by weight of one or more C₁₆ compounds and/or at least 33% by weight of one or more C₁₈ compounds.

The hydrocarbon feedstock of step d. or the hydrocarbon feedstock of step i. can be contacted with the fluidised catalytic cracking catalyst in an essentially liquid state, an essentially gaseous state or in a partially liquid-partially gaseous state. However, as catalytically cracking reactions can only occur in the gaseous phase, in embodiments where the hydrocarbon feedstock is present in an essentially or partially liquid state, the hydrocarbon feedstock, or part thereof, is preferably vaporised prior to or on contact with the fluidised catalytic cracking catalyst.

Preferably the hydrocarbon feedstock of step d. or the hydrocarbon feedstock of step i. is contacted with the fluid catalytic cracking catalyst at a temperature of at least 400° C., preferably at a temperature of from 400° ° C. to 800° C., more preferably at a temperature of from 450° C. to 750° C., more preferably a temperature of from 500° C. to 700° C., to produce a bio-oil comprising one or more cracked hydrocarbon products.

In some embodiments, the hydrocarbon feedstock is heated prior to contact with the fluidised catalytic cracking catalyst, for example the hydrocarbon feedstock may be heated to a temperature of at least 50° C., preferably at least 75° C., more preferably at least 100° C. prior to contact with the fluidised catalytic cracking catalyst. Preferably, hydrocarbon feedstock may be heated to a temperature of up to 200° C., preferably up 175° C., more preferably up to 150° ° C. prior to contact with the fluidised catalytic cracking catalyst. It has been found that where hydrocarbon feedstocks are maintained at a temperature below 50° C. hydrocarbon coking can occur within pipelines or nozzles leading to the fluidised catalytic cracking catalyst, reducing flow therein or blocking these structures. By maintaining the hydrocarbon feedstock at a temperature of at least 50° C., hydrocarbon coking can be significantly reduced or eliminated.

The hydrocarbon feedstock of step d. or the hydrocarbon feedstock of step i. may undergo fluidised catalytic cracking at a pressure of from 0.05 MPa to 10 MPa, preferably from 0.1 MPa to 8 MPa, more preferably from 0.5 MPa to 6 MPa.

The weight ratio of the hydrocarbon feedstock to fluidised catalytic cracking catalyst may be from 1:1 to 1:150, preferably from 1:2 to 1:100, more preferably from 1:5 to 1:50. It has been found that the above weight ratios of hydrocarbon feedstock and FCC catalyst enable effective cracking of the hydrocarbon feedstock at short residence times.

The fluidised catalytic cracking step may be performed in any suitable fluidised catalytic cracking reactor known in this field. For example, the fluidised catalytic cracking reactor may be selected from a fluidised dense bed reactor or a riser reactor. Preferably, the catalytic cracking reactor is a riser reactor.

Examples of suitable riser reactors are described in the Handbook titled “Fluid Catalytic Cracking technology and operations”, by Joseph W. Wilson, published by Penn Well Publishing Company (1997), chapter 3, pages 101 to 112. For example, the riser reactor may be an internal riser reactor or an external riser reactor as described therein. In particular, the riser reactor may comprise an essentially vertical upstream end located outside a vessel and an essentially vertical downstream end located inside the vessel or an essentially vertical downstream end located outside a vessel and an essentially vertical upstream end located inside the vessel. An internal riser reactor may be especially advantageous for use in accordance with the present invention as such reactors can be less prone to plugging, thereby increasing safety and hardware integrity.

A riser reactor as defined herein should be understood to mean an elongated essentially tubular-shaped reactor suitable for carrying out fluidised catalytic cracking reactions. The elongated essentially tubular-shaped reactor is preferably oriented in an essentially vertical manner.

The length of the riser reactor may be any length suitable for performing the fluidised catalytic cracking reaction and may depend on the required residence time of the hydrocarbon feedstock within the reactor. It is considered well within the knowledge of the skilled person to select a suitable riser length for performing the fluidised catalytic cracking step defined herein. However, for example, the FCC reactor may have a length of from 10 to 65 meters, preferably from 15 to 55 meters, more preferably from 20 to 45 meters.

The fluidised cracking catalyst reactor may comprise an inlet at or near the base of the fluidised catalytic cracking reactor in order to feed the hydrocarbon feedstock and/or fluidised catalytic cracking catalyst to the reactor, and an outlet at or near the top of the fluidised catalytic cracking reactor, wherein the bio-oil formed and de-activated catalyst are extracted from the fluidised catalytic cracking reactor.

By supplying the hydrocarbon feedstock at or near the base of the fluidised catalytic cracking reactor, water formed in-situ will occur at bottom of the reactor. Water formed in-situ may lower the hydrocarbon partial pressure and reduce second order hydrogen transfer reactions, resulting in higher olefin yields.

Preferably, the hydrocarbon feedstock of step d. or the hydrocarbon feedstock of step i. is atomised prior to or upon entry into the fluidised catalytic cracking reactor. The term atomising is herein understood to mean that the hydrocarbon feedstock is formed into a dispersion of liquid droplets in a gas. Preferably, the liquid droplets have an average diameter of from 10 μm to 60 μm, more preferably an average diameter of from 20 μm to 50 μm. In some embodiments, the hydrocarbon feedstock may be atomised in a feed nozzle by applying shear energy. Preferably the feed nozzle is a bottom entry feed nozzle or a side entry feed nozzle. By a bottom entry feed nozzle is herein understood that the feed nozzle protrudes from the bottom of the fluidised catalytic cracking reactor. By a side entry feed nozzle is herein understood that the feed nozzle protrudes from the side wall of the fluidised catalytic cracking reactor. The nozzle may be configured to atomise the hydrocarbon feedstock as it enters the fluidised catalytic cracking reactor, preferably the nozzle is configured to produce a cone shaped spray, a fan shaped spray or mist.

By atomising the hydrocarbon feedstock prior to or upon entry into the fluidised catalytic cracking reactor, the increased surface area of the hydrocarbon feedstock will enable more efficient transfer of heat thereto and improve the efficiency of conversion of a liquid or partially liquid hydrocarbon feedstock to a gaseous state.

Generally, fluidised catalytic cracking occurs as the gaseous hydrocarbon feedstock carries the fluidised catalytic cracking catalyst along the reactor length. Where the hydrocarbon feedstock is supplied at or near the base of the fluidised catalytic cracking reactor, it may be advantageous to also supply a lift gas at or near the base of the riser reactor. The velocity of the lift gas supplied to the reactor can be beneficially used to control the residence time of the hydrocarbon feedstock and/or FCC catalyst. The term residence time as used herein is considered to indicate the time period in which the fluidised catalytic cracking reactor is in contact with the gaseous hydrocarbon feedstock within the fluidised catalytic cracking reactor, of course the residence time includes not only the residence time of the hydrocarbon feedstock but also the residence time of its conversion products. Examples of suitable lift gases include steam, nitrogen, vaporized oil or mixtures thereof. Preferably, the lift gas is steam. In a preferred embodiment, the lift gas and the hydrocarbon feedstock may be combined prior to entry into the fluidised catalytic cracking reactor.

The hydrocarbon feedstock of step d. or the hydrocarbon feedstock of step i. may have a residence time of from 0.5 seconds to 15 seconds, preferably from 1 second to 10 seconds, more preferably from 2 seconds to 5 seconds.

The fluidised cracking catalyst may be in the form of particulates or a powder, preferably the fluidised cracking catalyst is in the form of a fine powder. As discussed above, the fluidised catalytic cracking processes requires that the hydrocarbon feedstock is contacted with the fluidised catalytic cracking catalyst in a gaseous state. Accordingly, the rate of catalytic cracking of the hydrocarbon feedstock will be, at least partially, dependent on the surface area and volume of the fluidised catalytic cracking catalyst freely available. Thus, preferably, the fluidised catalytic cracking catalyst is ground in order to reduce its particle size, for example through the use of a tube grinder, a mill, such as a hammer mill, knife mill, slurry milling, or resized through the use of a chipper, to the required particle size. In particular, the fluidised cracking catalyst may be in the form of particulates or a powder having a diameter of from 10 μm to 300 μm, preferably 15 μm to 200 μm, more preferably a diameter of from 20 μm to 150 μm. Catalysts having a particle sizes within these ranges have been found to be particularly useful for increasing efficiency of the catalytic cracking reaction.

The fluidised catalytic cracking catalyst can be any catalyst known to the skilled person to be suitable for use in a fluidised catalytic cracking process. Preferably, the fluidised catalytic cracking catalyst comprises a zeolite or high activity crystalline alumina silicate. The fluidised catalytic cracking catalyst may further comprise an amorphous binder compound and/or a filler. Examples of the amorphous binder components include silica, alumina, titania, zirconia and magnesium oxide, or combinations thereof. Examples of fillers include clays, such as kaolin. The use of a binder and/or filler material has been found to be beneficial as it enables the catalyst to be more homogeneously distributed throughout the hydrocarbon feed and therefore increases the amount of catalyst in contact with the hydrocarbon feed. Accordingly, the use of a catalyst in combination with a binder and/or filler material can reduce the amount of catalyst required for the fluidised catalytic cracking reaction, reducing the overall cost (operating and capex) of the process.

Where the fluidised catalytic cracking catalyst comprises a zeolite, the zeolite may be selected from a large pore zeolite, a medium pore zeolite, or combinations thereof.

The large pore zeolite is preferably selected from FAU or faujasite, such as synthetic faujasite, for example, zeolite Y or X, ultra-stable zeolite Y (USY), Rare Earth zeolite Y (REY) and Rare Earth USY (REUSY), more preferably the large pore zeolite is selected from an ultra-stable zeolite Y (USY).

In particular, the large pore zeolite may selected from a natural large-pore zeolite, such as gmelinite, chabazite, dachiardite, clinoptilolite, faujasite, heulandite, analcite, levynite, erionite, sodalite, cancrinite, nepheline, lazurite, scolecite, natrolite, offretite, mesolite, mordenite, brewsterite, and ferrierite and/or a synthetic large pore zeolite, such as zeolites X, Y, A, L. ZK-4, ZK-5, B, E, F, H, J, M, Q, T, W, Z, alpha and beta, omega, REY and USY zeolites, preferably the natural large pore zeolite is selected from faujasites, particularly zeolite Y, USY, and REY.

The large pore zeolite may comprise internal pores having a pore diameter of from 0.62 nm to 0.8 nm, wherein the pore diameter is measured along the major axis of the pores. The axes of zeolites are depicted in the ‘Atlas of Zeolite Structure Types’, of W. M. Meier, D. H. Olson, and Ch. Baerlocher, Fourth Revised Edition 1996, Elsevier, ISBN 0-444-10015-6.

The medium pore zeolite may be selected from a MFI type zeolite, for example, ZSM-5, a MFS type zeolite, a MEL type zeolites a MTW type zeolite, for example, ZSM-12, a MTW type zeolite, an EUO type zeolite, a MTT type zeolite, a HEU type zeolite, TON type zeolite, for example, theta-1, and/or a FER type zeolite, for example, ferrierite. Preferably, the medium pore zeolite is selected from ZSM-5, ZSM-12, ZSM-22, ZSM-23, ZSM-34, ZSM-35, ZSM-38, ZSM-48, ZSM-50, silicalite, and silicalite 2, more preferably the medium pore zeolite is ZSM-5.

The medium pore zeolite may comprise internal pores having a diameter of from 0.45 nm to 0.62 nm, wherein the pore diameter is measured along the major axis of the pores. The axes of zeolites are depicted in the ‘Atlas of Zeolite Structure Types’, of W. M. Meier, D. H. Olson, and Ch. Baerlocher, Fourth Revised Edition 1996, Elsevier, ISBN 0-444-10015-6.

It is known that the type and range of cracked olefins produced by a catalytic cracking reaction can vary depending on the type, and therefore selectivity, of the zeolite catalyst used. As discussed above, more stringent requirements are being applied to modern-day fuels, for example, the minimum octane values of fuels produced. Where FCC processes produce a range of cracked olefin products, the resulting fuel may not be of sufficient quality to meet these requirements. Accordingly, in some cases, further processing or upgrading techniques can be used to improve the quality of the fuel product. However, such additional processing steps increases both the time and expenditure required to produce a marketable product. Alternatively, or in addition, catalysts containing medium pore zeolites, are known to increase the yield of light olefins (C₂ to C₄), primarily propylene and butylenes, in cracked hydrocarbon products.

Light olefins are known to be high octane value compounds and can increase the volatility of the resulting fuel. Thus the inclusion of medium pore zeolites within the fluidised catalytic cracking process can improve the quality of the bio-oil formed, reducing the need for subsequent processing or upgrading steps. In addition to enhancing the volatility and octane number of the bio-oil formed, the increased amounts of light olefins can also reduce emissions of the resulting fuel. Ethylene, which can also be increased, is valuable as a chemical raw material.

In particular, ZSM-5 has been shown to produce significantly higher yields of lighter olefins (C₂ to C₄), for example increased yields of propylene.

As discussed above, the fluidised catalytic cracking catalyst may comprise a blend of one or more large pore zeolites and one or more medium pore zeolites, preferably the one or more large pore zeolite(s) are as defined above and/or and the one or more medium pore zeolite(s) are as defined above. In some embodiments, the weight ratio of large pore zeolites to medium pore zeolites is in the range of 99:1 to 70:30, preferably from 98:2 to 85:15.

Preferably, where a blend of fluidised catalytic cracking catalysts is selected comprising one or more large pore zeolites and one or more medium pore zeolites, at least one of the medium pore zeolites is selected from ZSM-5. More preferably, the ZSM-5 zeolite is present in an amount of from 1 to 20 wt %, preferably 2 to 15 wt %, more preferably 2 to 8 wt % based on the total weight of the catalyst.

The total amount of the large pore size zeolite and/or medium pore zeolite present in the fluidised cracking catalyst is preferably in the range of 5 wt % to 40 wt %, more preferably in the range of 10 wt % to 30 wt %, and even more preferably in the range of 10 wt % to 25 wt % relative to the total mass of the fluidised catalytic cracking catalyst.

The fluidised catalytic cracking catalyst can be contacted with the hydrocarbon fluid feed in a counter-current flow, a co-current flow or a cross-flow configuration, preferably the fluidised catalytic cracking catalyst is contacted with the hydrocarbon fluid feed in a co-current configuration.

Following the fluidised catalytic cracking process, the deactivated catalyst may be at least partially separated from the bio-oil formed. The separation step is preferably carried out using one or more cyclone separators and/or one or more swirl tubes.

In some embodiments, the process further comprises at least partially removing sulphur containing components from the bio-oil formed in step d. or step ii. In addition or alternatively, the process may further comprise at least partially removing sulphur containing components from the bio-derived gasoline fuel fraction formed in step e. or step iii.

The step of at least partially removing sulphur containing components from the bio-oil and/or gasoline fuel fraction may comprise at least partially removing one or more of thiols, sulphides, disulphides, alkylated derivatives of thiophene, benzothiophene, dibenzothiophene, 4-methyldibenzothiophene, 4,6-dimethyldibenzothiophene, benzonaphthothiophene and benzo[def]dibenzothiophene present in the hydrocarbon feedstock. Preferably, benzothiophene, dibenzothiophene are at least partially removed from the bio-oil and/or gasoline fuel fraction.

The step of at least partially removing sulphur containing components from the bio-oil and/or gasoline fuel fraction may comprise a hydro-desulphurisation step, preferably a catalytic hydro-desulphurisation step.

The catalyst is preferably selected from nickel molybdenum sulphide (NiMoS), molybdenum, molybdenum disulphide (MoS₂), cobalt/molybdenum such as binary combinations of cobalt and molybdenum, cobalt molybdenum sulphide (CoMoS), Ruthenium disulfide (RuS₂) and/or a nickel/molybdenum-based catalyst. More preferably, the catalyst is selected from a nickel molybdenum sulphide (NiMoS) based catalyst and/or a cobalt molybdenum sulphide (CoMoS) based catalyst.

Alternatively, the catalyst may be selected from any known metal organic framework (MOF) comprising a metal component and an organic ligand, suitable for at least partially removing sulphur containing components from the bio-oil and/or gasoline fuel fraction. In particular, the MOF material may be selected from copper-1,3,5-benzenetricarboxylic acid (Cu-BTC) and V/Cu-BTC. Preferably, the catalyst comprises V/Cu-BTC.

The catalyst may be a supported catalyst, wherein the support can be selected from a natural or synthetic material. In particular, the support selected from activated carbon, silica, alumina, silica-alumina, a molecular sieve, and/or a zeolite. The use of a support has been found to be beneficial as it enables the catalyst to be more homogeneously distributed throughout the hydrocarbon feed and therefore increases the amount of catalyst in contact with the bio-oil and/or gasoline fuel fraction. Accordingly, the use of a supported catalyst can reduce the amount of catalyst required for the hydro-desulphurisation reaction, reducing the overall cost (operating and capex) of the process.

The hydro-desulphurisation step may be performed in a fixed bed or trickle bed reactor to increase contact between the bio-oil and/or gasoline fuel fraction and the catalyst present to increase the efficiency of the sulphur removing step.

The hydro-desulphurisation step may be performed at a temperature of from 250° C. to 400° C., preferably from 300° C. and 350° C.

The bio-oil and/or gasoline fuel fraction may be pre-heated prior to contacting with the hydrogen gas and, where present the hydro-desulphurisation catalyst. The bio-oil and/or gasoline fuel fraction may be pre-heated through the use of a heat exchanger. Alternatively, the bio-oil and/or gasoline fuel fraction may be first contacted with the hydrogen gas and, if present, the hydro-desulphurisation catalyst, and subsequently heated to the desired temperature. The bio-oil and/or gasoline fuel fraction and hydrogen gas may be heated to the desired temperature using any of the direct or indirect heating methods defined above.

The hydro-desulphurisation step is performed at a reaction pressure of from 4 to 6 MPaG, preferably from 4.5 to 5.5 MPaG, more preferably about 5 MPaG.

During the desulphurisation reaction, sulphur containing components react with hydrogen gas to produce hydrogen sulphide gas (H₂S). The hydrogen sulphide gas formed can be separated from the hydrocarbon feedstock by any known method in this field, for example through the use of a gas separator or the application of a slight vacuum, for example a vacuum pressure of less than 6 KPaA, preferably less than 5 KPaA, more preferably less than 4 KPaA, to the reactor vessel.

Optionally, the reduced sulphur bio-oil and/or gasoline fuel fraction may then be cooled, by any suitable means known in the art, for example by use of a heat exchanger, before further processing steps are performed.

Trace amounts of hydrogen sulphide remaining in the reduced sulphur bio-oil and/or reduced sulphur gasoline fuel fraction may subsequently be removed through partial vaporisation, for example through the use of a flash separator at around ambient pressure and the vaporised hydrogen sulphide removed through degassing. Preferably, the bio-oil and/or gasoline fuel fraction has a temperature of between 60° C. and 120° C., more preferably the bio-oil and/or gasoline fuel fraction has a temperature of between 80° C. and 100° C., during the degassing step. The degassing step may be performed under a vacuum, preferably under a vacuum pressure of less than 6 KPaA, more preferably under a vacuum pressure of less than 5 KPaA, even more preferably under a vacuum pressure of less than 4 KPaA.

Any unreacted hydrogen-rich gas removed during the degassing step may be separated from hydrogen sulphide, for example through the use of an amine contactor. The separated gas may then be beneficially recycled and combined with the hydrocarbon feedstock of step d. or step i. By recycling the unreacted hydrogen-gas, the amount of hydrogen gas required to remove sulphur containing components from the bio-oil and/or gasoline fuel fraction is reduced, thereby providing a more cost-effective process.

The hydro-desulphurisation step may be repeated one or more times in order to achieve the desired sulphur reduction in the bio-oil and/or gasoline fuel fraction. However, typically only one hydro-desulphurisation step is required to sufficiently reduce the sulphur content of the bio-oil and/or gasoline fuel fraction to the desired level, especially when the hydrocarbon feedstock is produced in accordance with the methods described herein above.

The desulphurised bio-oil and/or gasoline fuel fraction may comprise a sulphur content of less than 5 ppmw, preferably less than 3 ppmw, more preferably less than 1 ppmw.

In some embodiments, the desulphurisation step will not be required. As discussed above, the biomass feedstock may be selected from non-crop biomass feedstocks. Non-crop biomass feedstocks, such as miscanthus, grass, and straw, such as rice straw or wheat straw, contain low amounts of sulphur, and so the hydrocarbon feedstock, bio-oil and gasoline fuel fraction resulting therefrom will inherently fall within the sulphur limitations stated above. In addition, sulphur containing components present in non-crop biomass feeds predominantly comprise benzothiophene, which is readily decomposed to form benzene and hydrogen sulphide (H₂S) at temperatures of approximately 500° C. Accordingly, such sulphur containing components will decompose during the pyrolysis process and/or fluidised catalytic cracking process as defined herein, further reducing the sulphur content of the resulting bio-oil. As a result, the use of such biomass feedstocks can reduce the time and costs associated with the present process.

In accordance with the present invention, the process may further comprise the step of deoxygenating the hydrocarbon feedstock prior to the fluidised catalytic cracking step, in order to at least partially remove oxygen-containing compounds (oxygenates) from the hydrocarbon feedstock. Unlike crude oil-based hydrocarbon feedstocks, bio-derived hydrocarbon feedstocks comprise oxygen-containing components, which are not readily converted into a form that can easily be integrated into an existing hydrocarbon-based infrastructure. For example, these oxygen containing components can poison catalysts commonly used in conventional fuel production processes. Furthermore, hydrocarbon feedstocks comprising oxygen containing components are not readily processed using fluidised catalytic cracking methods. The presence of oxygen containing hydrocarbons in a bio-fuel or a traditionally formed fossil fuel can produce high acidity and low energy conversion. These oxygenated hydrocarbons can also undergo secondary reactions during storage or when heated to produce undesirable compounds, such as oligomers, polymers, and other compounds which cause plugging and block liquid transport operations.

The term oxygenate refers to compounds containing at least one or more carbon atoms, one or more hydrogen atoms and one or more oxygen atoms. Oxygenates may include, for example aldehydes, carboxylic acids, alkanols, phenols and/or ketones.

Preferably, the deoxygenation step is a hydrodeoxygenation step, performed at a temperature of from 200° ° C. to 450° C., preferably from 250° C. to 400° C., more preferably from 280° C. to 350° C.

The hydrocarbon feedstock may be pre-heated prior to contacting with the hydrogen gas and, where present the hydrodeoxygenation catalyst. The hydrocarbon feedstock may be pre-heated through the use of a heat exchanger. Alternatively, the hydrocarbon feedstock may be first contacted with the hydrogen gas and, if present, the hydrodeoxygenation catalyst, and subsequently heated to the desired temperature. The hydrocarbon feedstock and hydrogen gas may be heated to the desired temperature using any of the direct or indirect heating methods defined above.

The water vapour formed can be separated from the hydrocarbon feedstock by any known method in this field, for example through the use of a gas separator or the application of a slight vacuum, for example a vacuum pressure of less than 6 KPaA, preferably less than 5 KPaA, more preferably less than 4 KPaA, to the reactor vessel.

Preferably, the hydrodeoxygenation step further comprises a hydrodeoxygenation catalyst. The hydrodeoxygenation step may be performed in a fixed bed or trickle bed reactor to increase contact between the hydrocarbon feedstock and the catalyst present, increasing the efficiency of the oxygen removing step.

The catalyst is preferably comprises a metal selected from Group VIII and/or Group VIB of the periodic table, in particular, the catalyst comprises a metal selected from Ni, Cr, Mo, W, Co, Pt, Pd, Rh, Ru, Ir, Os, Cu, Fe, Zn, Ga, In, V, and mixtures thereof.

The catalyst may be a supported catalyst, wherein the support can be selected from a natural or synthetic material. In particular, the support selected from alumina, amorphous silica-alumina, titania, silica, ceria, zirconia, carbon, silicon carbide or zeolite such as zeolite Y, zeolite beta, ZSM-5, ZSM-12, ZSM-22, ZSM-23, ZSM-48, SAPO-11, SAPO-41, and ferrierite. The use of a support has been found to be beneficial as it enables the catalyst to be more homogeneously distributed throughout the hydrocarbon feedstock and therefore increases the amount of catalyst in contact with the hydrocarbon feedstock. Accordingly, the use of a supported catalyst can reduce the amount of catalyst required for the hydrodeoxygenation reaction, reducing the overall cost (operating and capex) of the process.

Optionally, the reduced oxygen hydrocarbon feedstock may then be cooled, by any suitable means known in the art, for example by use of a heat exchanger, before further processing steps are performed.

Trace amounts of hydrogen remaining in the reduced oxygen hydrocarbon feedstock may subsequently be removed through partial vaporisation, for example through the use of a flash separator at around ambient pressure (including essentially atmospheric conditions) and the vaporised hydrogen removed through degassing. The degassing step may be performed under a vacuum, preferably under a vacuum pressure of less than 6 KPaA, more preferably under a vacuum pressure of less than 5 KPaA, even more preferably under a vacuum pressure of less than 4 KPaA.

Any unreacted hydrogen-rich gas removed during the degassing step may be beneficially recycled and combined with the hydrocarbon feedstock of step d. or step ii. By at least partially recycling the unreacted hydrogen-gas, the amount of hydrogen gas required to remove oxygen-containing components from the hydrocarbon feedstock is reduced, thereby providing a more cost-effective process.

The hydrodeoxygenation step may be repeated one or more times in order to achieve the desired oxygen reduction in the hydrocarbon feedstock. However, typically only one hydrodeoxygenation step is required to sufficiently reduce the oxygen content of the hydrocarbon feedstock to the desired level, especially when the hydrocarbon feedstock is produced in accordance with the methods described herein above.

The process may further comprise the step of hydro-treating the bio-oil formed in step e. or step ii.

The hydro-treating step of the present invention is used to reduce the number of unsaturated hydrocarbon functional groups present in the bio-oil and to beneficially convert the bio-oil to a more stable fuel with a higher energy density.

The hydro-treating step may be performed at a temperature of from 250° C. to 350° C., preferably from 270° ° C. to 330° C., more preferably from 280° ° C. to 320° C. Preferably, the bio-oil is heated prior to contact with the hydrogen gas and, where present, the hydro-treating catalyst. The bio-oil may be pre-heated through the use of a heat exchanger. Alternatively, the bio-oil may be first contacted with the hydrogen gas and, if present, the hydrotreating catalyst, and is subsequently heated to the desired temperature. The bio-oil and hydrogen gas may be heated to the desired temperature using any of the direct or indirect heating methods defined above.

The hydro-treating step may be performed at a reaction pressure of from 4 MPaG to 6 MPaG, preferably from 4.5 MPaG to 5.5 MPaG, more preferably about 5 MPaG.

In general, the hydro-treating treating step further comprises a catalyst. Preferably, the catalyst comprises a metal catalyst selected from Group IIIB, Group IVB, Group VB, Group VIB, Group VIIB, and Group VIII, of the periodic table. In particular, a metal catalyst selected from Group VIII of the periodic table, for example the catalyst may be selected from Fe, Co, Ni, Ru, Rh, Pd, Os, Ir, and/or Pt, such as a catalyst comprising Ni, Co, Mo, W, Cu, Pd, Ru, Pt. Preferably, the catalyst is selected from a CoMo, NiMo or Ni catalyst.

Where the hydro-treating catalyst is selected from a platinum-based catalyst, it is preferred that the hydro-desulphurisation step is performed prior to the hydro-treating step as sulphur contained with the hydrocarbon feedstock can poison platinum-based catalysts and thus reduce the efficiency of the hydro-treating step.

The catalyst may be a supported catalyst, and the support can be optionally selected from a natural or synthetic material. In particular, the support may be selected from activated carbon, silica, alumina, silica-alumina, a molecular sieve, and/or a zeolite. The use of a support has been found to be beneficial as the catalyst can be more homogeneously distributed throughout the bio-oil, increasing the amount of catalyst in contact with the bio-oil. Thus, the use of a supported catalyst can reduce the amount of catalyst required for the hydro-treating reaction, reducing the overall cost (operating and capex) of the process.

The hydro-treating step may be performed in a fixed bed or trickle bed reactor in order to increase the contact between the bio-oil and the catalyst present, thereby improving the efficiency of the hydro-treating reaction.

Optionally, the hydro-treated bio-oil is subsequently cooled, for example by use of a heat exchanger, before any further processing steps are performed.

Prior to fractionating the bio-oil formed, LPG gas may optionally be at least partially separated from the bio-oil by any known method in this field, for example through the use of a gas condenser and/or gas separator. Alternatively or in addition the LPG gas may be separated from the bio-oil by application of a slight vacuum, for example using a vacuum pressure of less than 6 KPaA, preferably less than 5 KPaA, more preferably less than 4 KPaA, to separate LPG from the remaining bio-oil. Alternatively, LPG may be separated from the bio-oil through condensation and flash distillation methods.

The fractionation step of the present invention can separate the refined bio-oil into the respective naphtha, gasoline, jet fuel and/or heavy diesel fractions. The fractionation method may be performed using any standard methods known in the art, for example through the use of a fractionation column.

The fractionation step may comprise separating a first fractionation cut having a cut point of between 30° ° C. and 220° C., preferably between 50° C. and 210° C., such as between 70° ° C. and 200° C. of the refined bio-oil at atmospheric pressure (including essentially atmospheric conditions). Alternatively, the fractionation step may be performed at a pressure of from 850 to 1000 Pa, preferably 900 to 950 Pa. The hydrocarbons in the first fractionation cut may be subsequently cooled and condensed. The first cut fraction is bio-derived gasoline fuel fraction.

The process may further comprise performing a second fractionation cut of the refined bio-oil, with a cut point between 280° C. and 320° ° C., preferably from 290° C. to 310° C., more preferably about 300° C. The second fractionation cut generally comprises a bio-derived jet fuel. The hydrocarbons in the second fractionation cut may cooled and condensed, for example using a condenser.

The second fractionation cut is a bio-derived jet fuel, preferably am A1 grade jet fuel. Preferably, the physical and chemical properties of the second fractionation cut meet at least some of the standardised requirements of a jet fuel.

The remaining bio-oil in the bottom stream is a bio-derived diesel fuel.

During the fluidised catalytic cracking step, coke and hydrocarbonaceous materials are deposited on the surface of the catalyst, resulting in a loss of catalyst activity and selectivity. Accordingly, the process may further comprise the step of regenerating the at least partially removed deactivated fluidised catalytic cracking catalyst. In particular, the at least partially removed deactivated fluidised catalytic cracking catalyst may be regenerated via the steps of:
a. stripping the deactivated catalyst to bio-oil absorbed on the surface of the catalyst; and
b. regenerating the catalyst.

The stripping step removes the hydrocarbonaceous reaction products adsorbed on the deactivated catalyst before the regeneration step. The products removed during the stripping step may be at least partially recycled and combined with the bio-oil produced in step e. or step ii.

Preferably, the stripping step comprises contacting the deactivated catalyst with a gas comprising steam at a temperature of from 400° C. to 800° C., preferably from 400° C. to 700° C., more preferably from 450° ° C. to 650° C. Preferably, the gas comprising steam is heated prior to contact with the deactivated catalyst. The gas may be pre-heated through the use of a heat exchanger. Alternatively, the deactivated catalyst may be first contacted with a gas comprising steam and is subsequently heated to the desired temperature. The deactivated catalyst and gas comprising steam may be heated to the desired temperature using any of the direct or indirect heating methods defined above.

The deactivated catalyst may be contacted with a gas comprising steam for any period of time required to sufficiently remove hydrocracking products adsorbed on the surface of the deactivated catalyst. In particular, the deactivated catalyst may be contacted with a gas comprising steam for a period of time of from 1 to 10 minutes, preferably 2 to 8 minutes, more preferably 3 to 6 minutes.

In preferred embodiments, the deactivated catalyst is contacted with a gas comprising steam in a weight ratio of from 10:1 to 100:1, preferably in a weight ratio of 20:1 to 60:1.

The regeneration step preferably comprises contacting the stripped fluidised catalytic cracking catalyst with air or a mixture of air and oxygen in a regenerator at a temperature of equal to or more than 550° C. to produce a regenerated catalytic cracking catalyst, heat and carbon dioxide. Preferably, the stripped fluidised catalytic cracking catalyst is contacted with air or a mixture of air and oxygen in a regenerator at a temperature of from 550° C. to 950° ° C., preferably 575° C. to 900° C., more preferably from 600° ° C. to 850° C.

During the regeneration step, coke deposited on the catalyst as a result of the fluidised catalytic cracking step is burned off to restore the catalyst activity. The combustion of coke on the surface of the catalyst is a highly exothermic reaction. Thus, the regeneration step not only serves to remove coke from the surface of the catalyst but also heats the catalyst to a temperature appropriate for endothermic fluidised catalytic cracking. Accordingly, the heated regenerated fluidised catalytic cracking catalyst can be at least partially recycled to the fluidised catalytic cracking step. Preferably, the catalyst is continuously circulated from the fluidised catalytic cracking step, to stripping and regeneration and back to the fluidised catalytic cracking step. The circulation rate of the catalyst can be adjusted relative to the feed rate of the hydrocarbon feedstock to maintain a heat balanced operation in which the heat produced in the regeneration step is sufficient for maintaining the fluidised catalytic cracking reaction with the circulating regenerated catalyst being used as the heat transfer medium.

Alternatively or in addition, the heat produced during the exothermic regeneration step may at least partially be used to heat water and/or generate steam. The steam produced may be used as a lift gas in the riser reactor. Alternatively or in addition the heat produced during the exothermic regeneration step may at least partially be used to preheat the hydrocarbon feedstock prior to the hydrodeoxygenation step and/or preheat the bio-oil prior to the hydro-treating step and/or preheat the bio-oil and/or gasoline fuel fraction prior to the desulphurisation step. Accordingly, by at least partially recycling the heat produced during the exothermic regeneration step, the overall cost (operating and capex) of the process can be reduced.

The regeneration step may be performed at a pressure of from 0.05 MPa to 1 MPa, preferably a pressure of from 0.1 MPa to 0.6 MPa.

A third embodiment comprises a bio-derived LPG fuel produced in accordance with the process defined herein.

A fourth embodiment comprises a bio-derived gasoline fuel produced in accordance with the process defined herein. Preferably, the bio-derived gasoline fuel is formed entirely from a biomass feedstock.

It has been surprisingly found that a bio-derived gasoline fuel produced in accordance with the processes of the present invention meets the criteria of a EURO VI gasoline fuel.

The bio-derived gasoline fuel may have a research octane number of at least 98, preferably at least 102, more preferably at least 105. The bio-derived gasoline fuel may have motor octane number of at least 88, preferably at least 90, more preferably at least 95.

The bio-derived gasoline fuel preferably comprises 10 ppmw or less of sulphur, preferably 5 ppmw or less of sulphur, more preferably 1 ppmw or less of sulphur.

Preferably, the bio-derived gasoline fuel has no measurable bromine index.

A fifth embodiment comprises a bio-derived jet fuel produced in accordance with the process defined herein.

A sixth embodiment comprises a bio-derived diesel fuel produced in accordance with the process defined herein.

It will be appreciated that although it is technically not essential, the bio-derived fuels of the present invention may be blended with other materials (such as fossil fuel derived fuel materials) in order to meet current fuel standards. By way of example such blending may be up to 50%. However, the surprising quality of the fuel of the present invention makes it feasible to be able to avoid such processes.

A seventh embodiment provides a system for forming a bio-gasoline fuel from a biomass feedstock, wherein the system comprises:
means for ensuring that the moisture content of the biomass feedstock is less than 10% by weight of the biomass feedstock;
a reactor comprising heating element configured to heat the biomass feedstock to a temperature of at least 950° C. to form a mixture of biochar, hydrocarbon feedstock, non-condensable light gases, such as hydrogen, carbon monoxide, carbon dioxide and methane, and water;
a separator, configured to separate the hydrocarbon feedstock formed from the reaction mixture produced in the reactor;
a fluidised catalytic cracking reactor suitable for cracking a hydrocarbon feedstock to produce a bio-oil; and
a separator, configured to separate a gasoline fuel fraction from the bio-oil.

In accordance with the present invention, the system may further comprises means for grinding the biomass feedstock before entering the reactor in order to reduce the particle size of the material, for example the biomass feedstock may be formed into pellets, chips, particulates or powders wherein the largest particle diameter is from 1 mm to 25 mm, 1 mm to 18 mm or 1 mm to 10 mm. Preferably, the system comprises a tube grinder, a mill, such as a hammer mill, knife mill, slurry milling, or a chipper, to reduce the particle size of the biomass feedstock.

In some examples, the system may further comprise heating means to reduce the moisture content of the biomass feedstock to less than 10% by weight. The heating means may be selected from a vacuum oven, a rotary dryer, a flash dryer or a heat exchanger, such as a continuous belt dryer. Preferably, the heating means are arranged to indirectly heat the biomass feedstock, for example the heating means may be selected from an indirect heat belt dryer, an indirect heat fluidised bed or an indirect heat contact rotary steam-tube dryer.

In accordance with the present invention, the heating element may be configured to heat the biomass feedstock to a temperature of at least 1000° C., more preferably at least 1100° C., for example 1120° C., 1150° ° C., or 1200° ° C.

The heating element may comprise microwave assisted heating, a heating jacket, a solid heat carrier, a tube furnace or an electric heater, preferably the heating element comprises a tube furnace.

Alternatively or in addition, the heating element may be positioned within the reactor and is configured to directly heat the biomass feedstock. By way of example, the heating element may be selected from an electric heating element, such as an electrical spiral heater. Preferably, two or more electrical spiral heaters may be arranged within the reactor.

The biomass feedstock may be transported continuously through the reactor, for example the biomass material may be contained on/within a conveyor, such as screw conveyor or a rotary belt. Optionally, two conveyors may be arranged to continuously transport the biomass material through the reactor.

The reactor may be arranged so that the biomass material is heated under atmospheric pressure (including essentially atmospheric conditions). Alternatively, the reactor may be arranged to form low pressure conditions, such as from 850 to 1,000 Pa, preferably 900 to 950 Pa. The reactor may be configured such that the reactor is maintained under vacuum in order to aid the removal of pyrolysis gases formed. Preferably, the reactor is configured to continuously transport the biomass material in a counter-current direction to any pyrolysis gases removed from the reactor using the applied vacuum. In this way, any solid material formed as a result of heating, such as biochar, is removed separate to pyrolysis gases formed.

In accordance with the present invention, the system may further comprise cooling means for condensing pyrolysis gases formed in the reactor in order to produce a hydrocarbon feedstock product and non-condensable light gases.

The system may further comprise means for separating the pyrolysis gas formed, for example through distillation.

The separator may be arranged to separate biochar from the hydrocarbon feedstock product. For example, the separator may comprise filtration means (such as the use of a ceramic filter), centrifugation, or cyclone or gravity separation.

In addition, or alternatively, the separator may comprise means for at least partially separating water from the hydrocarbon feedstock product. For example, the separator may comprise gravity oil separation apparatus, centrifugation, cyclone or microbubble separation means.

In addition or alternatively, the separator may comprise means for at least partially separating non-condensable light gases from the hydrocarbon feedstock product, for example the separator may be arranged such that the hydrocarbon feedstock product undergoes flash distillation or fractional distillation.

The separator may be arranged so as to recycle any non-condensable light gases separated from the hydrocarbon feedstock product to the biomass feedstock prior to entering the reactor.

Alternatively or in addition, where the separator may be arranged to at least partially separate carbon monoxide from the non-condensable gases formed. The system may further comprise means for converting the at least partially separated carbon monoxide to hydrogen gas and carbon dioxide via a water gas shift reaction. In particular, a reactor may be configured to contact the separated carbon monoxide with steam. The reactor further comprises a heating element configured to heat the carbon monoxide and steam to a temperature of from 205° ° C. to 482° C., more preferably 205° C. to 260° C. In some examples, the reactor comprises a shift catalyst selected from a copper-zinc-aluminium catalyst or a chromium or copper promoted iron-based catalyst. Preferably the catalyst is selected from a copper-zinc-aluminium catalyst.

In accordance with the present invention, the system may comprise means for further processing the hydrocarbon feedstock product formed. By way of example, the system may be arranged to remove contaminants present in the hydrocarbon feedstock, such as carbon, graphene and tar. Preferably, the system further comprises a filter, such as a membrane filter which can be used to remove larger contaminants present. In addition or alternatively, the system may further comprise fine filtration means, such as Nutsche filters, to remove smaller contaminants suspended in the hydrocarbon feedstock. Alternatively or in addition, the system may be arranged to contact the hydrocarbon feedstock with an active carbon compound and/or a crosslinked organic hydrocarbon resin in order to further process the hydrocarbon feedstock product produced. The activated carbon and/or crosslinked organic hydrocarbon resin may be in particulate or pellet form in order to increase contact between the adsorbent and hydrocarbon feedstock, thereby reducing the time required to achieve the desired level of contaminant removal. The hydrocarbon feedstock product may be contacted with the activated carbon and/or crosslinked organic hydrocarbon resin at around atmospheric pressure (including essentially atmospheric conditions). In some examples, the system may be arranged so that the hydrocarbon feedstock product is passed through the further processing means two or more times.

In accordance with the present invention, the fluidised catalytic cracking reactor may comprise a heating element configured to heat the hydrocarbon feedstock and fluidised catalytic cracking catalyst to a temperature of at least 400° C., preferably a temperature of from 400° C. to 800° C., more preferably a temperature of from 450° C. to 750° ° C., more preferably a temperature of from 500° C. to 700° ° C., to produce a bio-oil comprising one or more cracked hydrocarbon products.

In addition, the fluidised catalytic cracking reactor may be arranged to form pressure conditions of from 0.05 MPa to 10 MPa, preferably from 0.1 MPa to 8 MPa, more preferably from 0.5 MPa to 6 MPa.

The fluidised catalytic cracking reactor may be selected from a fluidised dense bed reactor or a riser reactor. Preferably, the catalytic cracking reactor is a riser reactor. For example, the riser reactor may be a so-called internal riser reactor or a so-called external riser reactor.

The riser reactor may be arranged to comprise an elongated essentially tubular-shaped reactor, preferably oriented in an essentially vertical manner.

The length of the riser reactor may length suitable for performing the fluidised catalytic cracking reaction. For example, fluidised catalytic cracking reactor may have a length of from 10 to 65 meters, preferably from 15 to 55 meters, more preferably from 20 to 45 meters.

The fluidised catalytic cracking reactor may be configured to comprise an inlet at or near the base in order to feed the hydrocarbon feedstock and/or fluidised catalytic cracking catalyst to the reactor, and an outlet at or near the top of the fluidised catalytic cracking reactor, wherein the bio-oil formed and de-activated catalyst are extracted from the fluidised catalytic cracking reactor.

Preferably, the fluidised catalytic cracking reactor is configured to atomise a hydrocarbon feedstock prior to or upon entry into the fluidised catalytic cracking reactor. The reactor may be arranged to disperse a hydrocarbon feedstock to form liquid droplets having an average diameter of from 10 μm to 60 μm, more preferably an average diameter of from 20 μm to 50 μm. In some examples, the reactor comprises a feed nozzle configured to applying shear energy to the hydrocarbon feedstock in order to form said dispersion. The nozzle may be configured to atomise the hydrocarbon feedstock as it enters the fluidised catalytic cracking reactor, preferably the nozzle is configured to produce a cone shaped spray, a fan shaped spray or mist.

The fluidised catalytic cracking reactor by be arranged such that the fluidised catalytic cracking catalyst contacts the hydrocarbon fluid feed in a counter-current flow, a co-current flow or a cross-flow configuration, preferably the fluidised catalytic cracking reactor by be arranged such that the fluidised catalytic cracking catalyst contacts the hydrocarbon fluid feed in a co-current configuration.

In addition, the system may further comprise means for at least partially separating the deactivated catalyst from the bio-oil formed. Preferably, the separation means are selected from one or more cyclone separators and/or one or more swirl tubes.

The system may further comprise means for at least partially removing sulphur containing components from the bio-oil formed or the bio-derived gasoline fuel fraction. The means for at least partially removing sulphur containing components from the hydrocarbon feedstock may comprise an inlet for supplying hydrogen gas to the reactor. The reactor may also comprise a hydro-desulphurisation catalyst, preferably a hydro-desulphurisation catalyst as defined above. In some examples, the means for at least partially removing sulphur components from the hydrocarbon feedstock may comprise a heating element arranged to heat the hydrocarbon feedstock to a temperature of from 250° C. to 400° C., preferably from 300° C. and 350° C. Optionally, the heating element may be arranged so as to heat the hydrocarbon feedstock to the required temperature before entering the reactor, by way of example the heating element may be selected from a heat exchanger. Alternatively, the heating element may be arranged so as to heat hydrocarbon feedstock to the required temperature after contact with the hydrogen gas and, where present, the hydrodesulphurisation catalyst. Where the hydrocarbon feed is heated subsequently to entering the reactor, the heating element may be selected from any of the direct or indirect heating methods defined above. In some examples, the means for least partially removing sulphur containing components from the hydrocarbon feedstock may be maintained under pressure a of from 4 to 6 MPaG, preferably from 4.5 to 5.5 MPaG, more preferably about 5 MPaG.

The reactor may further comprise means for removing hydrogen sulphide gas formed during the desulphurisation process, for example the reactor may further comprise a gas separator arranged to provide a slight vacuum, for example a vacuum pressure of less than 6 KPaA, more preferably a vacuum pressure of less than 5 KPaA, even more preferably a vacuum pressure of less than 4 KPaA, in order to aid the removal hydrogen sulphide gas present.

The system may further comprise cooling means, for example a heat exchanger, in order to cool the reduced sulphur hydrocarbon feedstock before further processing steps are performed.

Optionally, the system may further comprise means for partially vaporising the reduced sulphur hydrocarbon feedstock in order to remove trace amounts of hydrogen sulphide present. By way of example, the partially vaporising means may comprise a flash separator maintained at ambient pressure and a degasser to remove the vaporised hydrogen sulphide. The partially vaporising means may comprise a heating element arranged so as to heat the hydrocarbon feedstock to a temperature of between 60° C. and 120° C., more preferably a temperature of between 80° C. and 100° C., during the degassing step. Optionally, the degasser may be maintained under a vacuum pressure of less than 6 KPaA, more preferably under a vacuum pressure of less than 5 KPaA, even more preferably under a vacuum pressure of less than 4 KPaA.

Preferably, the reactor is configured to recycle any unreacted hydrogen-gas present following the desulphurisation step to the bio-derived hydrocarbon feedstock entering the reactor. In this way, the amount of hydrogen gas required to remove sulphur containing components in the bio-derived hydrocarbon feedstock is reduced, providing a more cost-effective system.

In some examples, the reactor is arranged such that the hydrocarbon feedstock flows through the means for at least partially removing sulphur containing components two or more times.

In addition or alternatively, the system may be configured to at least partially remove oxygen containing compounds from the hydrocarbon feedstock prior to entering the fluidised catalytic cracking reactor. Preferably, the means for at least partially removing oxygen containing compounds from the hydrocarbon feedstock. In some examples the means comprises a reactor having an inlet for supplying the hydrocarbon feed and hydrogen gas to the reactor. In some examples the reactor may be a fixed bed or trickle bed reactor. The reactor may further comprise a hydrodeoxygenation catalyst, as defined above. The reactor may further comprise a heating element arranged to heat the hydrocarbon feed to a temperature of from 200° ° C. to 450° ° C., preferably from 250° C. to 400° C., more preferably from 280° C. to 350° C., for example using any of the direct or indirect heating methods defined above.

The means for at least partially reducing the oxygen containing compounds from the hydrocarbon feed may further comprise means for at least partially separating water vapour formed the hydrocarbon feedstock, for example the means for at least partially removing water vapour formed may comprise a vacuum arranged to apply a vacuum pressure of less than 6 KPaA, preferably less than 5 KPaA, more preferably less than 4 KPaA, to the reactor vessel.

Optionally, the system may further comprise cooling means in order to reduce the temperature of the reduced oxygen hydrocarbon feedstock before further processing steps are performed. By way of example, the cooling means may comprise a heat exchanger.

In addition or alternatively, the system may further comprise degassing means for at least partially removing trace amounts of hydrogen remaining in the reduced oxygen hydrocarbon feedstock. In particular, the degassing means comprise a flash separator at around ambient pressure (including essentially atmospheric pressure). Preferably the degassing means are configured to apply a vacuum pressure to the reduced oxygen hydrocarbon feedstock. More preferably, the degassing means are configured to apply a vacuum pressure of less than 6 KPaA, more preferably less than 5 KPaA, even more preferably less than 4 KPaA.

Preferably, the reactor is configured to recycle any unreacted hydrogen-gas present following the deoxygenation step to the bio-derived hydrocarbon feedstock entering the reactor. In this way, the amount of hydrogen gas required to remove oxygen containing components in the bio-derived hydrocarbon feedstock is reduced, providing a more cost-effective system.

In addition or alternatively, the system may further comprise means for hydro-treating the bio-oil formed. The means for hydro-treating the bio-oil may comprise a hydro-treating catalyst, for example a hydro-treating catalyst as defined above. The hydro-treating means may further comprise a heating element arranged to heat the bio-oil to a temperature of from 250° C. to 350° C., preferably from 270° C. to 330° ° C., more preferably from 280° C. to 320° C. Optionally, the heating element may be arranged so as to heat the bio-oil to the required temperature before contacting the means for hydro-treating the hydrocarbon feedstock, by way of example the heating element may be selected from a heat exchanger. Alternatively, the heating element may be arranged so as to heat the bio-oil to the required temperature after contact with the hydrogen gas and, where present, the hydro-treating catalyst. Where the hydrocarbon feed is heated subsequent to contacting the hydro-treating means, the heating element may be selected from any of the direct or indirect heating methods defined above. In some examples, when used to perform a hydro-treating step, the reactor may be maintained under a pressure of from 4 to 6 MPaG, preferably from 4.5 to 5.5 MPaG, more preferably about 5 MPaG.

The system may further comprise cooling means, for example a heat exchanger in order to cool the hydro-treated bio-oil before further processing steps are performed.

Optionally the system may comprise means for at least partially separating LPG gas from the bio-oil. In particular, the system may further comprise degassing means such as a gas condenser and/or gas separator. In some examples, the degassing means are configured to apply a vacuum pressure to the bio-oil. More preferably, the degassing means are configured to apply a vacuum pressure of less than 6 KPaA, more preferably less than 5 KPaA, even more preferably less than 4 KPaA to at least partially remove LPG gases.

The separator may be configured to separate a first fractionation cut having a cut point of between 30° C. and 220° C., preferably between 50° C. and 210° C., such as between 70° ° C. and 200° ° C. of the refined bio-oil at atmospheric pressure (i.e. approximately 101.3 KPa). Alternatively, the separator may be arranged such that a first fractionation cut is separated at a pressure of from 850 to 1000 Pa, preferably 900 to 950 Pa.

The separator may further comprise means for cooling the first fractionation cut, for example the cooling means may be selected from a heat-exchanger.

Optionally, the separator may also be configured to separate a second fractionation cut having a cut point between 280° ° C. and 320° C., preferably from 290° ° C. to 310° C., more preferably about 300° C. The second fractionation cut generally comprises a bio-derived jet fuel.

As a further option, the separator may be arranged to collate the remaining bio-oil in the bottom stream is a bio-derived diesel fuel.

In some embodiments, the separator is selected from a fractionation column.

The present inventions as defined herein is illustrated in the accompanying drawings, in which:

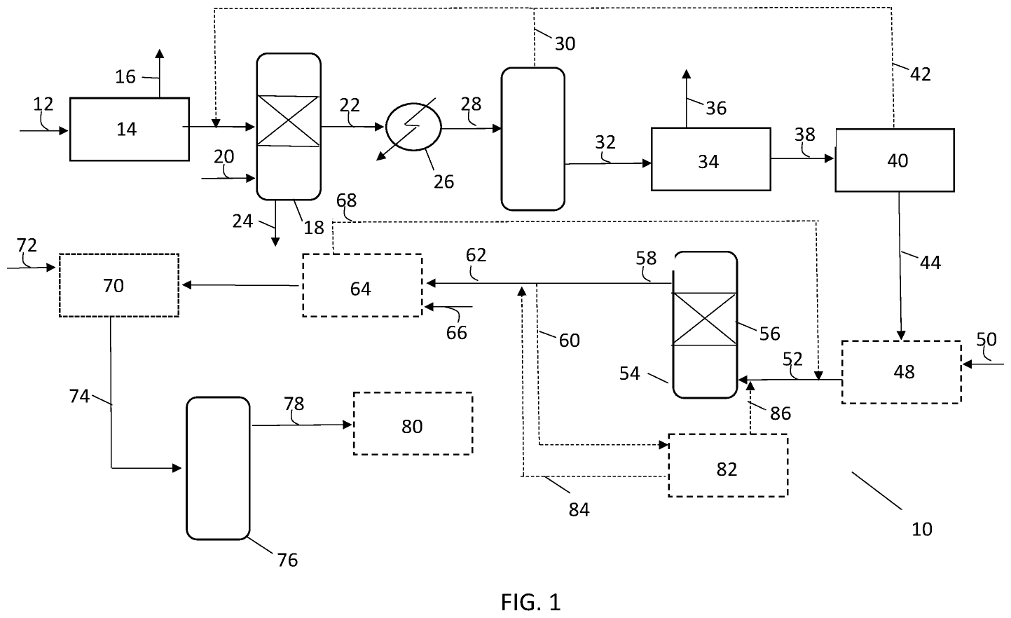

FIG. 1 illustrates a flow diagram of a process of forming a bio-gasoline fuel from a biomass feedstock in accordance with the present invention; and

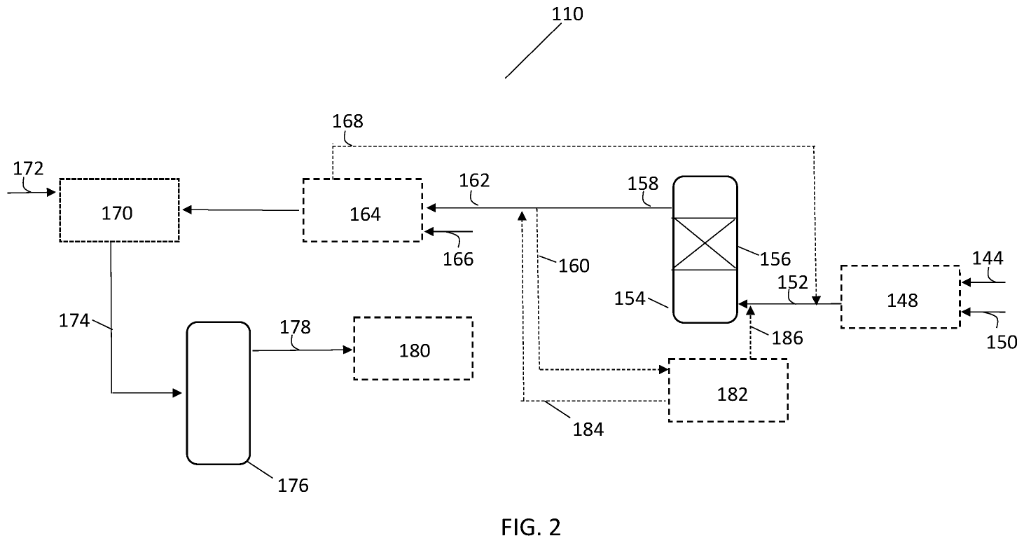

FIG. 2 illustrates a flow diagram of a process of forming a bio-gasoline fuel from a bio-derived hydrocarbon feedstock in accordance with the present invention.

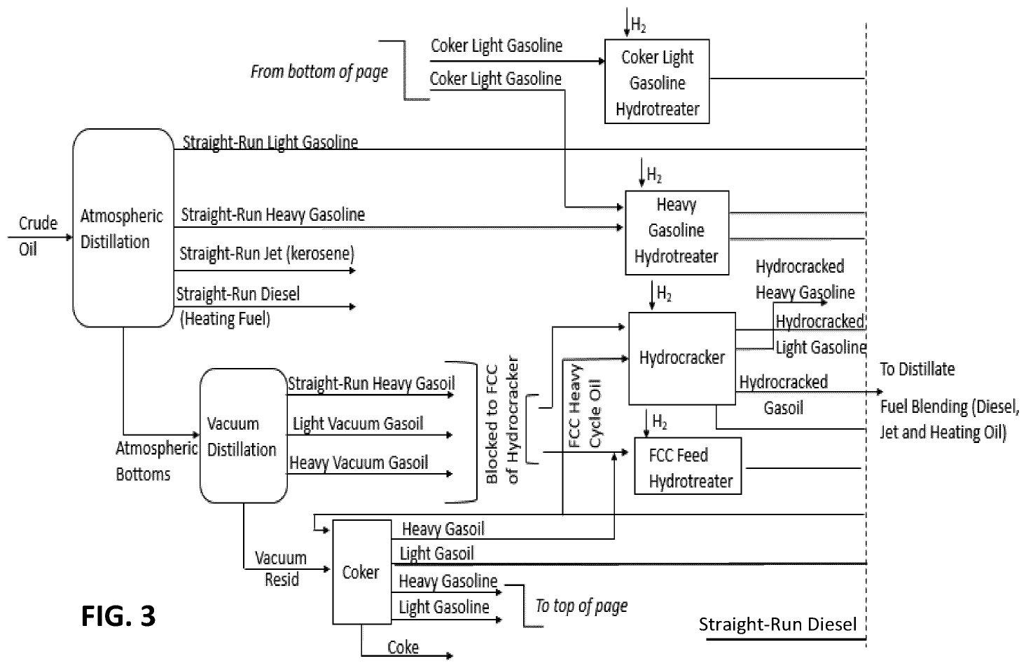

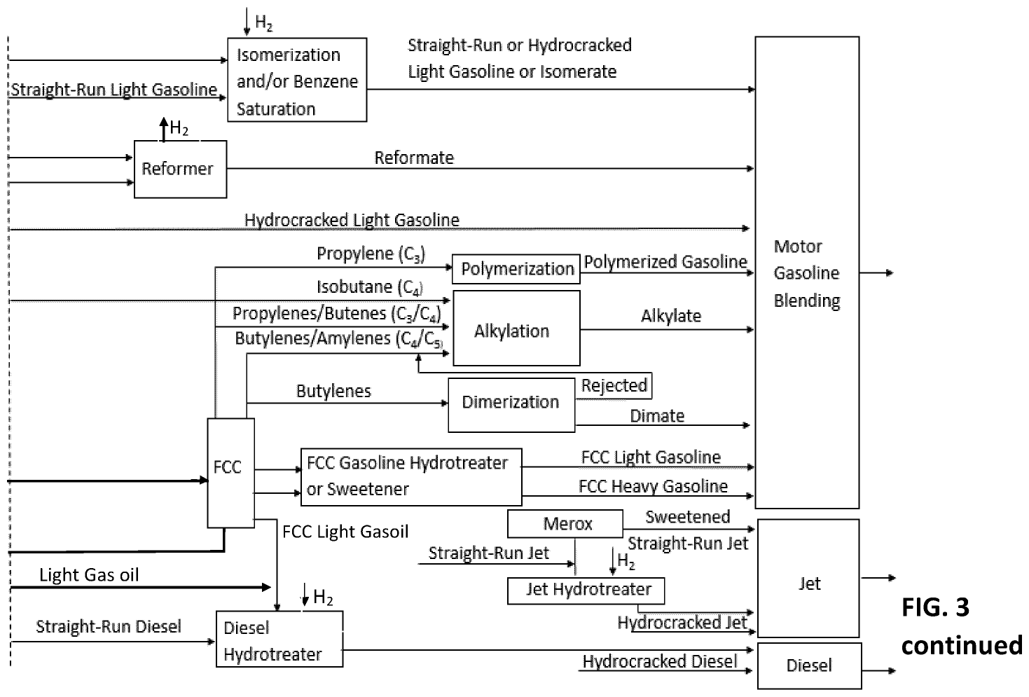

FIG. 3 illustrates a flow diagram of a known method of forming fuels based on standard FFC processes;

FIG. 1 illustrates a simplified process (10) of forming a bio-gasoline fuel from a biomass feedstock via a fluidised catalytic cracking reactor. Process steps illustrated in dashed lines are understood to be optional process steps.

A biomass feedstock stream (12) is fed into a feedstock oven or dryer (14) in order to ensure that the moisture content of the biomass feedstock is 10% or less by weight of the biomass feedstock. The feedstock oven or dryer may further comprise an outlet (16) in order to separate any water vapour removed from the biomass material. The low moisture biomass material my then be supplied to a pyrolysis reactor (18), wherein the low moisture biomass material is heated to a temperature of at least 1000° C., more preferably at least 1100° C., for example 1120° C., 1150° C., or 1200° C. The biomass material may be pyrolysed under a low pressure, such as from 850 to 1,000 Pa, preferably 900 to 950 Pa. The pyrolysis reactor further comprises an inlet (20) in order to supply an inert gas, such as nitrogen or argon to the pyrolysis reactor prior to the pyrolysis step being performed. The resulting pyrolysis gases can subsequently be removed from the pyrolysis reactor via an outlet (22). The pyrolysis reactor further comprises a further outlet (24) for removing any remaining solids formed during the pyrolysis reaction, such as biochar. The hydrocarbon feedstock product may be at least partially separated from the biochar formed using filtration methods (such as the use of a ceramic filter), centrifugation, cyclone or gravity separation.

The pyrolysis gas extracted from the pyrolysis reactor (22) is supplied to a cooling means (26) in order to condense pyrolysis gases formed to produce a hydrocarbon feedstock product and non-condensable light gases the hydrocarbon feedstock can then be transferred to a distillation column (28) wherein the non-condensable light gases are removed from the top of the distillation column (30) and the hydrocarbon feedstock is removed from the bottom of the distillation column (32). The non-condensable light gases (30) separated from the hydrocarbon feedstock product may be at least partially recycled to the low moisture biomass feedstock stream (18). The separated hydrocarbon feedstock (32) is supplied to a separator (34) to at least partially remove water from the hydrocarbon feedstock product (32). For example, the separator may comprise gravity oil separation apparatus, centrifugation, cyclone or microbubble separation means. The separator comprises a first outlet (36) through which water can be removed from the hydrocarbon feedstock and a second outlet (38) through which the reduced water hydrocarbon feedstock can be obtained.

The reduced water hydrocarbon feedstock can be fed into a reactor (40) to at least partially remove contaminants contained therein, such as carbon, graphene, polyaromatic compounds and tar. The reactor may comprise a filter such as a membrane or a Nutsche to remove larger and smaller contaminants, respectively. Alternatively or in addition, an active carbon compound and/or a crosslinked organic hydrocarbon resin to remove contaminants, such as polycyclic aromatic compounds. As an alternative to activated carbon, the reactor may comprise biochar, to remove contaminants from the low moisture hydrocarbon feed. The reactor comprises an outlet (42) in order to separate contaminants from the hydrocarbon feedstock. Where the contaminants separated from the hydrocarbon feedstock comprise tar, the separated tar can be at least partially recycled and combined with the low moisture biomass feedstock stream (18).

The processed hydrocarbon feedstock (44) may then be fed into a deoxygenating reactor (48) comprising a hydrodeoxygenation catalyst, wherein the reactor further comprises an inlet (50) to supply a hydrogen containing gas to the deoxygenating reactor (48). The deoxygenating reactor heats the hydrocarbon feedstock (44), hydrogen-containing gas and hydrodeoxygenation catalyst to a temperature of from 200° ° C. to 450° C., preferably from 250° C. to 400° ° C., more preferably from 280° C. to 350° C.

The reduced oxygen containing hydrocarbon feedstock (52) is then supplied to a fluidised catalytic cracking reactor (54). An example of a fluidised catalytic cracking system is also illustrated in FIG. 3. FIG. 1 shows that the fluidised catalytic cracking reactor comprises an inlet (56) at or near the bottom of the fluidised catalytic cracking reactor (54) in order to feed the hydrocarbon feedstock and/or fluidised catalytic cracking catalyst to the reactor, and an outlet (58) at or near the top of the fluidised catalytic cracking reactor (54), wherein the bio-oil formed and de-activated catalyst are extracted from the fluidised catalytic cracking reactor (54). The fluidised catalytic cracking reactor heats the hydrocarbon feedstock and fluidised catalytic cracking catalyst to a temperature of at least 400° C., preferably at a temperature of from 400° C. to 800° C., more preferably at a temperature of from 450° ° C. to 750° C., more preferably a temperature of from 500° ° C. to 700° ° C. The fluidised catalytic cracking process may be performed at a pressure of from 0.05 MPa to 10 MPa, preferably from 0.1 MPa to 8 MPa, more preferably from 0.5 MPa to 6 MPa.

The deactivated catalyst (60) is at least partially separated from the bio-oil formed. The separation step is preferably carried out using one or more cyclone separators and/or one or more swirl tubes.

The separated bio-oil (62) is fed into a desulphurisation reactor (64) comprising a hydro-desulphurisation catalyst, wherein the desulphurisation reactor further comprises an inlet (66) to supply a hydrogen-containing gas to the reactor. The desulphurisation reactor heats the bio-oil, hydrogen-containing gas and hydro-desulphurisation catalyst to a temperature of from 250° C. to 400° C., preferably from 300° C. and 350° ° C.

The desulphurisation step may be performed at a pressure of from 4 to 6 MPaG, preferably from 4.5 to 5.5 MPaG, more preferably about 5 MPaG.

The desulphurisation reactor may further comprise a gas separator to remove hydrogen sulphide formed from the bio-oil. Optionally, the reduced sulphur bio-oil and/or gasoline fuel fraction may then be cooled, by any suitable means known in the art, for example by use of a heat exchanger. Trace amounts of hydrogen sulphide remaining in the reduced sulphur bio-oil and/or reduced sulphur gasoline fuel fraction may subsequently be removed through partial vaporisation, for example through the use of a flash separator at around ambient pressure and the vaporised hydrogen sulphide removed through degassing. Preferably, the bio-oil and/or gasoline fuel fraction has a temperature of between 60° C. and 120° C., more preferably the bio-oil and/or gasoline fuel fraction has a temperature of between 80° C. and 100° C., during the degassing step. The degassing step may be performed under a vacuum, preferably under a vacuum pressure of less than 6 KPaA, more preferably under a vacuum pressure of less than 5 KPaA, even more preferably under a vacuum pressure of less than 4 KPaA.

Any unreacted hydrogen-rich gas (68) removed during the degassing step may be separated from hydrogen sulphide, for example through the use of an amine contactor. The separated gas is then at least partly recycled and combined with the reduced oxygen containing hydrocarbon feedstock (52).

The reduced sulphur bio-oil is then fed into a hydro-treating reactor (70) comprising a hydro-treating catalyst to reduce the number of unsaturated hydrocarbon functional groups present in the bio-oil and to beneficially convert the bio-oil to a more stable fuel with a higher energy density.

The hydro-treating reactor further comprises an inlet (72) to supply a hydrogen-containing gas to the reactor. The hydrotreating reactor heats the bio-oil, hydrogen-containing gas and hydro-treating catalyst to a temperature of from 250° C. to 350° C., preferably from 270° C. to 330° C., more preferably from 280° ° C. to 320° C.

The hydro-treating step may be performed at a reaction pressure of from 4 MPaG to 6 MPaG, preferably from 4.5 MPaG to 5.5 MPaG, more preferably about 5 MPaG.

The hydrotreated bio-oil (74) is then transferred to a fractionation column (76), wherein the fractionation column separates a first fractionation cut having a cut point of between 30° C. and 220° C., preferably between 50° C. and 210° ° C., such as between 70° C. and 200° C. of the refined bio-oil at atmospheric pressure (including essentially atmospheric conditions). Alternatively, the fractionation step may be performed at a pressure of from 850 to 1000 Pa, preferably 900 to 950 Pa. The first fractionation cut can be removed from the fractionation column via an outlet (78). The first cut fraction is bio-derived gasoline fuel fraction.

In addition to reducing the sulphur containing compounds of the bio-oil via the desulphurisation reactor (64) or instead of this desulphurisation step, the bio-derived gasoline fuel (78) may be fed into a desulphurisation reactor (80), to at least partly remove sulphur containing components in the bio-fuel. The desulphurisation reactor (80) is as defined above.

The process (10) may further comprise a catalyst regenerator (82) comprising a catalyst stripping reactor and a catalyst regenerating reactor. The deactivated catalyst (60) separated from the bio-oil is at least partially recycled to a catalyst stripping reactor to remove absorbed catalyst cracking products thereon. The stripping step comprises contacting the deactivated catalyst with a gas comprising steam at a temperature of from 400° C. to 800° ° C., preferably from 400° C. to 700° C., more preferably from 450° C. to 650° C. Alternatively, the deactivated catalyst may be first contacted with a gas comprising steam and is subsequently heated to the desired temperature.

The products removed during the stripping step (84) may be at least partially recycled and combined with the bio-oil (62).

The stripped fluidised catalytic cracking catalyst is then contacted with air or a mixture of air and oxygen in a regeneration reactor at a temperature of equal to or more than 550° C. to produce a regenerated catalytic cracking catalyst, heat and carbon dioxide. Preferably, the stripped fluidised catalytic cracking catalyst is contact with air or a mixture of air and oxygen in a regenerator at a temperature of from 550° ° C. to 950° C., preferably 575° C. to 900° ° C., more preferably from 600° C. to 850° C.

The regeneration step may be performed at a pressure of from 0.05 MPa to 1 MPa, preferably a pressure of from 0.1 MPa to 0.6 MPa.

The regenerated fluidised catalytic cracking catalyst (86) is then, at least partially, be recycled to the fluidised catalytic cracking reactor (54).

FIG. 2 illustrates an alternative simplified process (110) of forming a bio-gasoline fuel from a bio-derived hydrocarbon feedstock. Process steps illustrated in dashed lines are understood to be optional process steps.

A bio-derived hydrocarbon feedstock (144) comprising at least 0.1% by weight of one or more C₈ compounds, at least 1% by weight of one or more C₁₀ compounds, at least 5% by weight of one or more C₁₂ compounds, at least 5% by weight of one or more C₁₆ compounds and at least 30% by weight of at least one or more C₁₈ compounds is fed into a deoxygenating reactor (148) comprising a hydrodeoxygenation catalyst, wherein the reactor further comprises an inlet (150) to supply a hydrogen containing gas to the deoxygenating reactor (148). The deoxygenating reactor heats the bio-derived hydrocarbon feedstock (144), hydrogen-containing gas and hydrodeoxygenation catalyst to a temperature of from 200° ° C. to 450° C., preferably from 250° C. to 400° ° C., more preferably from 280° C. to 350° C.

The reduced oxygen containing hydrocarbon feedstock (152) is then supplied to a fluidised cracking catalyst reactor (154). An example of a fluidised catalytic cracking system is also illustrated in FIG. 3. FIG. 2 shows that the fluidised catalytic cracking reactor comprises comprising an inlet (156) at or near the bottom of the fluidised catalytic cracking reactor (154) in order to feed the hydrocarbon feedstock and/or fluidised catalytic cracking catalyst to the reactor, and an outlet (158) at or near the top of the fluidised catalytic cracking reactor (154), wherein the bio-oil formed and de-activated catalyst are extracted from the fluidised catalytic cracking reactor (154). The fluidised catalytic cracking reactor heats the hydrocarbon feedstock and fluidised catalytic cracking catalyst to a temperature of at least 400° C., preferably at a temperature of from 400° C. to 800° ° C., more preferably at a temperature of from 450° ° C. to 750° C., more preferably a temperature of from 500° C. to 700° C. The fluidised catalytic cracking process may be performed at a pressure of from 0.05 MPa to 10 MPa, preferably from 0.1 MPa to 8 MPa, more preferably from 0.5 MPa to 6 MPa.

The deactivated catalyst (160) is at least partially separated from the bio-oil formed. The separation step is preferably carried out using one or more cyclone separators and/or one or more swirl tubes.

The separated bio-oil (162) is fed into a desulphurisation reactor (164) comprising a hydro-desulphurisation catalyst, wherein the desulphurisation reactor further comprises an inlet (166) to supply a hydrogen-containing gas to the reactor. The desulphurisation reactor heats the bio-oil, hydrogen-containing gas and hydro-desulphurisation catalyst to a temperature of from 250° C. to 400° C., preferably from 300° C. and 350° C.

The desulphurisation step may be performed at a pressure of from 4 to 6 MPaG, preferably from 4.5 to 5.5 MPaG, more preferably about 5 MPaG.

The desulphurisation reactor may further comprise a gas separator to remove hydrogen sulphide formed from the bio-oil. Optionally, the reduced sulphur bio-oil and/or gasoline fuel fraction may then be cooled, by any suitable means known in the art, for example by use of a heat exchanger. Trace amounts of hydrogen sulphide remaining in the reduced sulphur bio-oil and/or reduced sulphur gasoline fuel fraction may subsequently be removed through partial vaporisation, for example through the use of a flash separator at around ambient pressure and the vaporised hydrogen sulphide removed through degassing. Preferably, the bio-oil and/or gasoline fuel fraction has a temperature of between 60° ° C. and 120° C., more preferably the bio-oil and/or gasoline fuel fraction has a temperature of between 80° C. and 100° C., during the degassing step. The degassing step may be performed under a vacuum, preferably under a vacuum pressure of less than 6 KPaA, more preferably under a vacuum pressure of less than 5 KPaA, even more preferably under a vacuum pressure of less than 4 KPaA.

Any unreacted hydrogen-rich gas (168) removed during the degassing step may be separated from hydrogen sulphide, for example through the use of an amine contactor. The separated gas is then at least partly recycled and combined with the reduced oxygen containing hydrocarbon feedstock (152).

The reduced sulphur bio-oil is then fed into a hydro-treating reactor (170) comprising a hydro-treating catalyst to reduce the number of unsaturated hydrocarbon functional groups present in the bio-oil and to beneficially convert the bio-oil to a more stable fuel with a higher energy density.

The hydro-treating reactor further comprises an inlet (172) to supply a hydrogen-containing gas to the reactor. The hydrotreating reactor heats the bio-oil, hydrogen-containing gas and hydro-treating catalyst to a temperature of from 250° C. to 350° C., preferably from 270° C. to 330° C., more preferably from 280° ° C. to 320° C.

The hydro-treating step may be performed at a reaction pressure of from 4 MPaG to 6 MPaG, preferably from 4.5 MPaG to 5.5 MPaG, more preferably about 5 MPaG.

The hydrotreated bio-oil (174) is then fed into a fractionation column (176), wherein the fractionation column separates a first fractionation cut having a cut point of between 30° C. and 220° C., preferably between 50° C. and 210° C., such as between 70° C. and 200° ° C. of the refined bio-oil at atmospheric pressure (including essentially atmospheric conditions). Alternatively, the fractionation step may be performed at a pressure of from 850 to 1000 Pa, preferably 900 to 950 Pa. The first fractionation cut can be removed from the fractionation column via an outlet (178). The first cut fraction is bio-derived gasoline fuel fraction.

In addition to reducing the sulphur containing compounds of the bio-oil via the desulphurisation reactor (164) or instead of this desulphurisation step, the bio-derived gasoline fuel (178) may be fed into a desulphurisation reactor (180), to at least partly remove sulphur containing components in the bio-fuel. The desulphurisation reactor (180) is as defined above.

The process (110) may further comprise a catalyst regenerator (182) comprising a catalyst stripping reactor and a catalyst regenerating reactor. The deactivated catalyst (160) separated from the bio-oil is fed into the catalyst stripping reactor to removed absorbed catalyst cracking products. The stripping step comprises contacting the deactivated catalyst with a gas comprising steam at a temperature of from 400° ° C. to 800° C., preferably from 400° C. to 700° C., more preferably from 450° C. to 650° C. Alternatively, the deactivated catalyst may be first contacted with a gas comprising steam and is subsequently heated to the desired temperature.

The products removed during the stripping step (184) may be at least partially recycled and combined with the bio-oil (162).

The stripped fluidised catalytic cracking catalyst is then contacted with an oxygen containing gas in a regeneration reactor at a temperature of equal to or more than 550° C. to produce a regenerated catalytic cracking catalyst, heat and carbon dioxide. Preferably, the stripped fluidised catalytic cracking catalyst with an oxygen containing gas in a regenerator at a temperature of from 550° C. to 950° C., preferably 575° C. to 900° C., more preferably from 600° C. to 850° C.

The regeneration step may be performed at a pressure of from 0.05 MPa to 1 MPa, preferably a pressure of from 0.1 MPa to 0.6 MPa.

The regenerated fluidised catalytic cracking catalyst (186) is then, at least partially, be recycled to the fluidised catalytic cracking reactor (154).

1. A process for forming a bio-gasoline fuel from a biomass feedstock, comprising the steps of:
a. providing a biomass feedstock;
b. ensuring the moisture content of the biomass feedstock is 10% or less by weight of the biomass feedstock;
c. pyrolysing the low moisture biomass feedstock at a temperature of at least 950° C. to form a mixture of biochar, hydrocarbon feedstock, non-condensable light gases, such as hydrogen, carbon monoxide, carbon dioxide and methane, and water;
d. separating the hydrocarbon feedstock from the mixture formed in step c.;
e. cracking the hydrocarbon feedstock of step d. using a fluidised catalytic cracking (FCC) process to produce a bio-oil; and
f. fractionating the resulting bio-oil to obtain a bio-derived gasoline fuel fraction.

2. A process according to claim 1, wherein the biomass feedstock comprises cellulose, hemicellulose or lignin-based feedstocks.

3. A process according to claim 1 or claim 2, wherein the biomass feedstock is a non-food crop biomass feedstock, preferably the non-crop biomass feedstock is selected from miscanthus, switchgrass, garden trimmings, straw, such as rice straw or wheat straw, cotton gin trash, municipal solid waste, palm fronds/empty fruit bunches (EFB), palm kernel shells, bagasse, wood, such as hickory, pine bark, Virginia pine, red oak, white oak, spruce, poplar, and cedar, grass hay, mesquite, wood flour, nylon, lint, bamboo, paper, corn stover, or a combination thereof.

4. A process according to any one of claims 1 to 3, wherein the biomass feedstock is in the form of pellets, chips, particulates or a powder, preferably the pellets, chips, particulates or powder have a diameter of from 5 μm to 10 cm, such as from 5 μm to 25 mm, preferably from 50 μm to 18 mm, more preferably from 100 μm to 10 mm.

5. A process according to claim 4, wherein the pellets, chips, particulates or powder have a diameter of at least 1 mm, such as from 1 mm to 25 mm, 1 mm to 18 mm or 1 mm to 10 mm.

6. A process according to any preceding claim, wherein the initial moisture content of the biomass feedstock is up to 50% by weight of the biomass feedstock, such as up to 45% by weight of the biomass feed stock, or for example up to 30% by weight of the biomass feedstock.

7. A process according to any preceding claim, wherein the moisture content of the biomass feedstock is reduced to 7% or less by weight, such as 5% or less by weight of the biomass feedstock.

8. A process according to any preceding claim, wherein the step of ensuring the moisture content of the biomass feedstock is 10% or less by weight of the biomass feedstock comprises reducing the moisture content of the biomass feedstock.

9. A process according to claim 8 wherein the moisture content of the biomass feedstock is reduced by use of a vacuum oven, a rotary dryer, a flash dryer or a heat exchanger, such as a continuous belt dryer, preferably wherein the moisture content of the biomass feedstock is reduced through the use of indirect heating, for example by using an indirect heat belt dryer, an indirect heat fluidised bed or an indirect heat contact rotary steam-tube dryer.

10. A process according to any preceding claim, wherein the low moisture biomass feedstock is pyrolysed at temperature of at least 1000° C., more preferably at a temperature of at least 1100° C.

11. A process according to any preceding claim, wherein heat is provided to the pyrolysis step by means of convection heating, microwave heating, electrical heating or supercritical heating.

12. A process according to claim 11, wherein the heat source comprises microwave assisted heating, a heating jacket, a solid heat carrier, a tube furnace or an electric heater, preferably the heating source is a tube furnace.

13. A process according to claim 11, wherein the heat source is positioned inside the reactor, preferably wherein the heat source comprises one or more electric spiral heaters, such as a plurality of electric spiral heaters.

14. A process according to any preceding claim, wherein the low moisture biomass is pyrolysed at atmospheric pressure or wherein the low moisture biomass is pyrolysed under a pressure of from 850 to 1000 Pa, preferably from 900 to 950 Pa and, optionally, wherein the pyrolysis gases formed are separated through distillation.

15. A process according to any preceding claim, wherein the low moisture biomass feedstock is pyrolysed for a period of from 10 seconds to 2 hours, preferably, from 30 seconds to 1 hour, more preferably from 60 seconds to 30 minutes, such as 100 seconds to 10 minutes.

16. A process according to any preceding claim, wherein the pyrolysis reactor is arranged such that the low moisture biomass is conveyed in a counter-current direction to any pyrolysis gases formed, and optionally wherein biochar formed as a result of the pyrolysis step leaves pyrolysis reactor separate to the pyrolysis gases.

17. A process according to claim 16, wherein the pyrolysis gases are subsequently cooled, for example through the use of a venturi, to condense the hydrocarbon feedstock product.

18. A process according to any preceding claim, wherein step d. comprises at least partially separating biochar from the hydrocarbon feedstock product, preferably wherein biochar is at least partially separated by filtration (such as by use of a ceramic filter), centrifugation, or cyclone or gravity separation; and/or
wherein step d. comprises at least partially separating water from the hydrocarbon feedstock product, preferably the water at least partially separated further comprises organic contaminants, more preferably the water at least partially separated from the hydrocarbon feedstock product is a pyroligneous acid, even more preferably wherein water is at least partially separated from the hydrocarbon feedstock product by gravity oil separation, centrifugation, cyclone or microbubble separation; and/or
wherein step d. comprises at least partially separating non-condensable light gases from the hydrocarbon feedstock product, preferably wherein non-condensable light gases are at least partially separated from the hydrocarbon feedstock product by use of flash distillation or fractional distillation.

19. A process according to claim 18, wherein the separated non-condensable light gases are recycled and optionally combined with the low moisture biomass feedstock in step c.

20. A process according to claim 18, wherein carbon monoxide present in the non-condensable light gases is contacted with steam in a water gas shift reaction to produce carbon dioxide and a bio-derived hydrogen gas, preferably wherein the water gas shift reaction is performed at a temperature of from 205° C. to 482° C., more preferably a temperature of from 205° C. to 260° C.

21. A process according to claim 20, wherein the water gas shift reaction further comprises a shift catalyst, preferably the shift catalyst is selected from a copper-zinc-aluminium catalyst or a chromium or copper promoted iron-based catalyst, more preferably the shift catalyst is a copper-zinc-aluminium catalyst.

22. A process according to any preceding claim, further comprising the step of filtering the hydrocarbon feedstock product to at least partially remove contaminants, such as carbon, graphene, polyaromatic compounds and/or tar, contained therein, preferably the filtration step comprises the use of a membrane filter to remove larger contaminants and/or fine filtration to remove smaller contaminants, for example by using a Nutsche filter.

23. A process according to any one of claim 22, wherein the filtration step comprises contacting the hydrocarbon feedstock product with an active carbon compound and/or a crosslinked organic hydrocarbon resin and subsequently separating the hydrocarbon feedstock product from the active carbon and/or crosslinked organic hydrocarbon resin compound though filtration.

24. A process according to claim 23, wherein the active carbon compound and/or crosslinked organic hydrocarbon resin is contacted with the hydrocarbon feedstock product at around atmospheric pressure; and/or
wherein the active carbon compound and/or crosslinked organic hydrocarbon resin is contacted with the hydrocarbon feedstock product for at least 15 minutes before separation, preferably at least 20 minutes, more preferably at least 25 minutes; and/or
wherein the step of filtering the hydrocarbon feedstock is performed once or is repeated one or more times.

25. A process according to any one of claims 22 to 24, wherein the tar removed from the hydrocarbon feedstock is recycled and optionally combined with the low moisture biomass feedstock in step c.

26. A process for forming a bio-gasoline fuel from a bio-derived hydrocarbon feedstock, comprising the steps of:
i. providing a bio-derived hydrocarbon feedstock comprising at least 0.1% by weight of one or more C₈ compounds, at least 1% by weight of one or more C₁₀ compounds, at least 5% by weight of one or more C₁₂ compounds, at least 5% by weight of one or more C₁₆ compounds and at least 30% by weight of one or more C₁₈ compounds;
ii. cracking the hydrocarbon feedstock of step i. using a fluidised catalytic cracking (FCC) process to produce a bio-oil; and
iii. fractionating the resulting bio-oil to obtain a bio-derived gasoline fuel fraction.

27. A process according to any preceding claim, wherein the hydrocarbon feedstock of step d. as defined in any one of claims 1 to 25 or the hydrocarbon feedstock of step i. as defined in claim 26 undergoes FCC at a temperature of from 400° C. to 800° C., preferably at a temperature of from 450° C. to 750° C., more preferably a temperature of from 500° C. to 700° ° C.

28. A process according to any preceding claim, wherein the hydrocarbon feedstock of step d. as defined in any one of claims 1 to 25 or the hydrocarbon feedstock of step i. as defined in claim 26 undergoes FCC at a pressure of from 0.05 MPa to 10 MPa, preferably from 0.1 MPa to 8 MPa, more preferably from 0.5 MPa to 6 MPa.

29. A process according to any preceding claim, wherein the hydrocarbon feedstock is contacted with the fluidised cracking catalyst at a weight ratio of from 1:1 to 1:150, preferably from 1:2 to 1:100, more preferably from 1:5 to 1:50.

30. A process according to any preceding claim, wherein the FCC process is performed in a fluidised catalytic cracking reactor, such as a fluidised dense bed reactor or a riser reactor, preferably the FCC reactor is a riser reactor, more preferably the riser reactor is selected from an internal riser reactor or an external riser reactor.

31. A process according to claim 30, wherein the hydrocarbon feedstock of step d. as defined in any one of claims 1 to 25 or the hydrocarbon feedstock of step i. as defined in claim 26 and the fluidised cracking catalyst are supplied at an inlet at or near the base of the FCC reactor, and wherein the bio-oil formed and de-activated catalyst are extracted from an outlet at or near the top of the FCC reactor.

32. A process according to claim 30 or 31, wherein the hydrocarbon feedstock of step d. as defined in any one of claims 1 to 25 or the hydrocarbon feedstock of step i. as defined in claim 26 is atomised prior to or upon entry into the FCC reactor, preferably the hydrocarbon feedstock is atomised to a droplet size of from 10 μm to 60 μm, more preferably a droplet size of from 20 μm to 50 μm.

33. A process according to any one of claims 30 to 32, wherein a lift gas is supplied to the FCC reactor through an inlet at or near the base of the reactor, preferably the lift gas is selected from steam, nitrogen, or vaporised oil.

34. A process according to any one of claims 30 to 33, wherein the hydrocarbon feedstock of step d. as defined in any one of claims 1 to 25 or the hydrocarbon feedstock of step i. as defined in claim 26 is in contact with the fluidised cracking catalyst in the FCC reactor for a period of from 0.5 seconds to 15 seconds, preferably from 1 second to 10 seconds, more preferably from 2 seconds to 5 seconds.

35. A process according to any preceding claim, wherein the fluidised cracking catalyst is in the form of particulates or a powder, preferably the fluidised cracking catalyst is in the form of a fine powder.

36. A process according to claim 35, wherein the particulates or powder have a diameter of from 10 μm to 300 μm, preferably 15 μm to 200 μm, more preferably a diameter of from 20 μm to 150 μm.

37. A process according to any preceding claim, wherein the fluidised cracking catalyst comprises a zeolite or high activity crystalline alumina silicate, and optionally further comprises an amorphous binder compound and/or a filler, preferably the amorphous binder compound is selected from silica, alumina, titania, zirconia and magnesium oxide, or combinations thereof and/or the filler is selected from a clay, such as kaolin.

38. A process according to claim 37, wherein the zeolite is a large pore zeolite, preferably the large pore zeolite is selected from FAU or faujasite, preferably synthetic faujasite, for example, zeolite Y or X, ultra-stable zeolite Y (USY), Rare Earth zeolite Y (REY) and Rare Earth USY (REUSY), more preferably the large pore zeolite is selected from an ultra-stable zeolite Y (USY).

39. A process according to claim 37 or 38, wherein the zeolite is a large pore zeolite, preferably selected from a natural large-pore zeolite, such as gmelinite, chabazite, dachiardite, clinoptilolite, faujasite, heulandite, analcite, levynite, erionite, sodalite, cancrinite, nepheline, lazurite, scolecite, natrolite, offretite, mesolite, mordenite, brewsterite, and ferrierite and/or a synthetic large pore zeolite, such as zeolites X, Y, A, L. ZK-4, ZK-5, B, E, F, H, J, M, Q, T, W, Z, alpha and beta, omega, REY and USY zeolites, preferably the large pore zeolite is preferably selected from faujasites, particularly zeolite Y, USY, and REY.

40. A process according to claims 38 to 39, wherein the large pore zeolite comprises internal pores having a pore diameter of from 0.62 nm to 0.8 nm.

41. A process according to claim 37, wherein the zeolite is a medium pore zeolite, preferably the medium pore zeolite is a MFI type zeolite, for example, ZSM-5, a MFS type zeolite, a MEL type zeolites a MTW type zeolite, for example, ZSM-12, a MTW type zeolite, an EUO type zeolite, a MTT type zeolite, a HEU type zeolite, TON type zeolite, for example, theta-1, and/or a FER type zeolite, for example, ferrierite.

42. A process according to claim 41, wherein the medium pore zeolite is selected from ZSM-5, ZSM-12, ZSM-22, ZSM-23, ZSM-34, ZSM-35, ZSM-38, ZSM-48, ZSM-50, silicalite, and silicalite 2, preferably the medium pore zeolite is ZSM-5.

43. A process according to claim 41 or 42, wherein the medium pore zeolite has internal pores having a diameter of from 0.45 nm to 0.62 nm.

44. A process according to any one of claims 37 to 43 wherein the zeolite catalyst comprises a blend of one or more large pore zeolites, as defined in any one of claims 38 to 40 and one or more medium pore zeolites, as defined in any one of claims 41 to 43.

45. A process according to claim 44, wherein the weight ratio of large pore zeolites to medium pore zeolites is in the range of 99:1 to 70:30, preferably from 98:2 to 85:15.

46. A process according to any preceding claim, wherein the fluidised cracking catalyst is arranged to contact the hydrocarbon feedstock of step d. as defined in any one of claims 1 to 25 or the hydrocarbon feedstock of step i. as defined in claim 26 in a counter-current flow, a co-current flow or a cross-flow configuration.

47. A process according to any preceding claim, wherein the process further comprises at least partially removing the deactivated catalyst from the bio-oil formed, preferably the deactivated catalyst is at least partially removed from the bio-oil using one or more cyclones and/or one or more swirl tubes.

48. A process according to any preceding claim, wherein the process further comprises at least partially removing sulphur containing components from the bio-oil formed and/or the bio-derived gasoline fuel fraction, preferably the sulphur removal step comprises a catalytic hydro-desulphurisation step.

49. A process according to claim 48, wherein the catalyst is part of a fixed bed or a trickle bed reactor.

50. A process according to claim 48 or 49, wherein the catalyst is selected from a nickel molybdenum sulphide (NiMoS), molybdenum, molybdenum disulphide (MoS₂), cobalt/molybdenum, cobalt molybdenum sulphide (CoMoS) and/or a nickel/molybdenum based catalyst, and preferably wherein the catalyst is selected from a nickel molybdenum sulphide (NiMoS) based catalyst, preferably the catalyst is a supported catalyst, such as by means of a support selected from activated carbon, silica, alumina, silica-alumina, a molecular sieve, and/or a zeolite.

51. A process according to any one of claims 48 to 50, wherein the hydro-desulphurisation step is performed at a temperature of from 250° C. to 400° C., preferably from 300° C. and 350° C.; and/or wherein the hydro-desulphurisation step is performed at a reaction pressure of from 4 to 6 MPaG, preferably from 4.5 to 5.5 MPaG, more preferably about 5 MPaG.

52. A process according to any one of claims 48 to 51, wherein the catalytic hydro-desulphurisation process further comprises the step of degassing the reduced sulphur bio-oil and/or gasoline fuel fraction to remove hydrogen disulphide gas, such as by cooling the reduced sulphur bio-oil and/or gasoline fuel fraction to a temperature of from 60 to 120° C., preferably from 80 to 100° C. and optionally applying a vacuum pressure of less than 6 KPaA, preferably less than 5 KPaA, more preferably less than 4 KPaA.

53. A process according to any preceding claim wherein the process further comprises deoxygenating the separated hydrocarbon feedstock of step d. as defined in any one of claims 1 to 25 or the hydrocarbon feedstock of step i. as defined in claim 26.

54. A process according to claim 53, wherein the deoxygenation steps is a hydrodeoxygenation step performed at a temperature of from 200° ° C. to 450° C., preferably from 250° C. to 400° C., more preferably from 280° ° C. to 350° C. and/or wherein the hydrodeoxygenation step is performed at a pressure of from 1 MP to 30 MPa, preferably from 5 MPa to 30 MPa.

55. A process according to claim 53 or 54, wherein the hydrodeoxygenation step further comprises a catalyst, such as a catalyst as part of a fixed bed or a trickle bed reactor.

56. A process according to claim 55, wherein the catalyst comprises a metal selected from Group VIII and/or Group VIB of the periodic table, preferably the catalyst comprises a metal selected from Ni, Cr, Mo, W, Co, Pt, Pd, Rh, Ru, Ir, Os, Cu, Fe, Zn, Ga, In, V, and mixtures thereof, more preferably the catalyst is a supported catalyst, such as by means of a support selected from alumina, amorphous silica-alumina, titania, silica, ceria, zirconia, carbon, silicon carbide or zeolite such as zeolite Y, zeolite beta, ZSM-5, ZSM-12, ZSM-22, ZSM-23, ZSM-48, SAPO-11, SAPO-41, and ferrierite.

57. A process according to any preceding claim, wherein the process further comprises hydro-treating the bio-oil formed.

58. A process according to claim 57, wherein the hydro-treating step is performed at a temperature of from 250° C. to 350° C., preferably from 270° C. to 330° C., more preferably from 280° ° C. to 320° C.; and/or wherein the hydro-treating step is performed at a reaction pressure of from 4 MPaG to 6 MPaG, preferably from 4.5 MPaG to 5.5 MPaG, more preferably about 5 MPaG.

59. A process according to claim 57 or 58, wherein the hydro-treating process further comprises a catalyst, such as a catalyst as part of a fixed bed or a trickle bed reactor.

60. A process according to claim 59, wherein the catalyst comprises a metal selected from Group IIIB, Group IVB, Group VB, Group VIB, Group VIIB, and Group VIII, of the periodic table, preferably the catalyst comprises a metal selected from Group VIII of the periodic table, preferably the catalyst comprises Fe, Co, Ni, Ru, Rh, Pd, Os, Ir, and/or Pt, such as a catalyst comprising Ni, Co, Mo, W, Cu, Pd, Ru, Pt, and preferably wherein the catalyst is selected from CoMo, NiMo or Ni, more preferably wherein the catalyst is a supported catalyst, such as by means of a support selected from activated carbon, silica, alumina, silica-alumina, a molecular sieve, and or a zeolite.

61. A process according to any preceding claim, further comprising the step of at least partially removing LPG from the bio-oil by condensation and/or flash distillation.

62. A process according claim 61, further comprising the step of applying a vacuum pressure of less than 6 KPaA to the bio-oil, preferably less than 5 KPaA, more preferably less than 4 KPaA, to separate LPG from the remaining bio-oil.

63. A process according to any one of claims 1 to 62, wherein the fractionation step comprises separating a first fractionation cut having a cut point of between 30° C. and 220° C., preferably between 50° C. and 210° C., more preferably between 70° C. and 200° C. of the bio-oil under atmospheric pressure, wherein the separated fraction is collected as a bio-derived gasoline fuel.

64. A process according to claim 63, wherein the process further comprises performing a second fractionation cut having a cut point between 280° C. and 320° C., preferably from 290° C. to 310° C., more preferably about 300° C. of the boil-oil under atmospheric pressure, wherein the separated fraction is collected as a bio-derived jet-fuel.

65. A process according to claim 64, wherein the process comprises collecting the bottom stream of the bio-oil as a bio-derived diesel fuel.

66. A process according to any one of claims 47 to 65, wherein the at least partially removed catalyst undergoes regeneration, comprising the steps of:
a. stripping the deactivated catalyst to remove bio-oil absorbed on the surface of the catalyst; and
b. regenerating the catalyst.

67. A process according to claim 66, wherein the stripping step comprises contacting the deactivated catalyst with a gas comprising steam at a temperature of from 400° C. to 800° C., preferably from 400° C. to 700° C., more preferably from 450° C. to 650° C., preferably wherein the deactivated catalyst is contacted with a gas comprising steam for a period of 1 to 10 minutes, preferably 2 to 8 minutes, more preferably 3 to 6 minutes.

68. A process according to claim 67, wherein the deactivated catalyst is contacted with a gas comprising steam in a weight ratio of from 10:1 to 100:1, preferably in a weight ratio of 20:1 to 60:1.

69. A process according to any one of claims 66 to 68, wherein the catalyst is regenerated by contacting the stripped catalyst with an oxygen containing gas at a temperature of from 550° ° C. to 950° C., preferably 575° C. to 900° ° C., more preferably from 600° C. to 850° C. and/or wherein the regeneration step is performed at a pressure of from 0.05 MPa to 1 MPa, preferably a pressure of from 0.1 MPa to 0.6 MPa.

70. A process according to any one of claims 66 to 69, wherein the regenerated catalyst is at least partly recycled to the FCC process.

71. A bio-derived LPG fuel formed by a process according to any one of claims 1 to 62; and/or
A bio-derived gasoline fuel formed by a process according to any one of claims 1 to 63, preferably the bio-derived gasoline fuel is formed entirely from a biomass feedstock and/or
A bio-derived jet fuel formed by a process according to any one of claims 1 to 64 and/or
A bio-derived diesel fuel formed by a process according to any one of claims 1 to 65.
